(19) United States
(12) Patent Application Publication
(10) Pub. No.: US 2026/0351217 A1
(43) Pub. Date: Nov. 5, 2026

(54) METHOD AND DEVICE FOR ADJUSTABLE ENERGY REDUCTION CONTROL OF VISUAL CONTENT USING ALTERNATING COMPLEMENTARY COLORS

(71) Applicant: InterDigital CE Patent Holdings, SAS, Paris (FR)

(72) Inventors: Laurent BLONDE, THORIGNE-FOUILLARD (FR); Claire-Helene DEMARTY, MONTREUIL LE GAST (FR); Franck AUMONT, VERN SUR SEICHE (FR); Olivier LE MEUR, TALENSAC (FR); Erik REINHARD, HEDE-BAZOUGES (FR)

(21) Appl. No.: 19/487,682

(22) PCT Filed: May 16, 2024
(86) PCT No.: PCT/EP2024/063489

§ 371 Date: Nov. 25, 2025

(30) Foreign Application Priority Data
May 26, 2023 (EP) 23305836.1

(51) Int. Cl. G09G 5/00

(52) U.S. Cl. CPC G09G 5/003; G09G 2320/103; G09G 2330/021; G09G 2354/00

(57) ABSTRACT

A method introduces the notion of a quality/energy tradeoff control for visual contents allowing to provide increased energy reduction compared to the spatially alternating complementary colors or temporally alternating complementary colors processing algorithms, at the cost of a decrease in terms of quality of experience. It is proposed to allow the user to control the balance between energy consumption reduction and quality of experience via the use of an algorithm strength parameter. Algorithm strength is a parameter in the algorithm performing the energy reduction on the video images, such that, depending on its value, different and continuous energy reduction levels are reached, and a corresponding quality of experience is obtained. More precisely, when using the alternating complementary colors algorithms, the algorithm strength will determine the radius of a color similarity volume that will define the size of the search space for a pair of replacement colors.

### CROSS-REFERENCE TO RELATED APPLICATIONS

This application claims the priority to European Application No 23305836.1 filed 26 May 2023, which is incorporated herein by reference in its entirety.

### TECHNICAL FIELD

The disclosure is in the field of multimedia content distribution, and at least one embodiment relates more specifically to controlling the level of energy consumption reduction when using spatially alternating complementary colors or temporally alternating complementary colors energy reduction processing algorithms in systems handling visual content such as an image or video.

### BACKGROUND ART

Reducing energy consumption of electronic devices has become a requirement not only for manufacturers of electronic devices but also to limit, as much as possible, the environmental impact and to contribute to the emergence of a sustainable display industry. The increase in display resolution from SD to HD, then to 4K and soon to 8K and beyond, as well as the introduction of high dynamic range imaging, has brought about a corresponding increase in energy requirements of display devices. This is not consistent with the global need to reduce energy consumption knowing that a huge number of devices has a display (i.e., TV, Mobile phones, tablets, etc.). Indeed, displays are the most important source of energy consumption, for consumer electronic devices, either battery-powered (e.g., smartphones, tablets, head-mounted displays, car display screens) or not (e.g., television sets, advertisement display panels).

Different display technologies have been developed in the recent years. Although modern displays consume energy in a more controllable and efficient manner than older displays, they remain the most important source of energy consumption in a video chain.

As far as backlight displays are concerned, their energy consumption is largely determined by the intensity of the backlight.

Organic Light Emitting Diode (OLED) is one example of display technology that is finding increasingly widespread use because of numerous advantages compared to former technologies such as Thin-Film Transistor Liquid Crystal Displays (TFT-LCDs). Rather than using a uniform backlight, OLED displays, as well as mini LEDS, are composed of individual directly emissive image pixels. OLEDs power consumption is therefore highly correlated to the image content and the power consumption for a given input image can be estimated by considering the values of the displayed image pixels.

It is therefore interesting to elaborate energy-aware images or videos, i.e., images or videos that will need less energy when displayed, notably on consumer electronics OLED displays. Techniques have been developed to reduce the energy consumption for example using spatially alternating complementary colors (SACC) or temporally alternating complementary colors (TACC). What is common within the techniques described in both applications is that they relate to the reduction of the energy requirements of display devices with the goal to preserve the quality of experience (QoE) based on contrast, luminance, temporal smoothness, or color levels for instance and exploit the principles of alternating complementary colors, as further described below.

### SUMMARY

With the current energy awareness context and the fight against climate change, facing the need to reduce energy footprint in the consumer electronics domain, SACC and TACC image processing algorithms have been developed with the common objective of minimizing the energy consumed by displays when using (for example displaying) video images and maximizing the quality of experience for the user.

Embodiments described hereafter have been designed with the foregoing in mind and introduce the notion of a quality/energy tradeoff control for visual contents allowing to provide increased energy reduction compared to the SACC and TACC processing algorithms, at the cost of a decrease in terms of quality of experience. It is proposed to allow the user to control the balance between energy consumption reduction and quality of experience via the use of an algorithm strength (AS) parameter. Algorithm strength is a parameter in the algorithm performing the energy reduction on the video images, such that, depending on its value, different and continuous energy reduction levels are reached and a corresponding QoE is obtained. More precisely, when using the alternating complementary colors algorithms, the algorithm strength will determine the radius of a color similarity volume that will define the size of the search space for a pair of replacement colors. A small value for the algorithm strength will result into a small color similarity volume and thus puts the emphasis on quality. A large value for the algorithm strength will result into a large color similarity volume and thus puts the emphasis on energy reduction. In other words, the value of the algorithm strength determines the impact of the algorithm on the energy consumption reduction and the quality of experience of the video content.

The algorithm strength may be adjusted directly by the user through interactive elements of a user interface or indirectly though user preferences or device setting parameters. Therefore, a user wanting to favor the quality of experience for a given visual content (for example a block buster movie) may set a minimal value for the algorithm strength so that they get a maximal quality. For another visual content (for example a talk show on climate change), the user may set a maximal value for the algorithm strength since they are willing to accept a reduced quality of experience.

A first aspect is directed to a method comprising determining a color similarity volume around an input color based on an obtained value representing a strength of an energy reduction algorithm, performing a set of first iterations over the color similarity volume, each iteration selecting a target color sampled within the determined color similarity volume, performing a set of second iterations over a color space, each iteration selecting a first color within the color space according to a selection criterion, determining a pair of colors comprising the first color of one of the second iterations and a symmetrical color of the first color with regard to the target color, adding the pair of colors to a set of candidate pairs if the energy required for two spatially adjacent pixels of half size or two temporally successive pixels of half duration of colors of the pair of colors is smaller than the energy required for a pixel of the input color, when the first and second iterations are completed, selecting one of the pairs of colors of the set of candidate pairs to be associated with the input color.

A second aspect is directed to a method comprising obtaining a visual content, obtaining a value representative of a strength for an algorithm that reduces the energy consumption needed for the visual content, determining a modified visual content by applying the algorithm on the visual content with the obtained algorithm strength value, and providing the modified visual content, wherein the algorithm implements the method of the first aspect.

A third aspect is directed to an apparatus comprising a processor configured to determine a color similarity volume around an input color based on an obtained value representing a strength of an energy reduction algorithm, perform a set of first iterations over the color similarity volume, each iteration selecting a target color sampled within the determined color similarity volume, performing a set of second iterations over a color space, each iteration selecting a first color within the color space according to a selection criterion, determine a pair of colors comprising the first color of one of the second iterations and a symmetrical color of the first color with regard to the target color, add the pair of colors to a set of candidate pairs if the energy required for two spatially adjacent pixels of half size or two temporally successive pixels of half duration of colors of the pair of colors is smaller than the energy required for a pixel of the input color, and when the first and second iterations are completed, select one of the pairs of colors of the set of candidate pairs to be associated with the input color.

A fourth aspect is directed to an apparatus comprising a processor configured to obtain a visual content, obtain a value representative of a strength for an algorithm that reduces the energy consumption needed for the visual content, determine a modified visual content by applying the algorithm on the visual content with the obtained algorithm strength value and provide the modified visual content, wherein the algorithm implements the method of the first aspect.

In at least one embodiment of first, second, third, and fourth aspects, the value representative of a strength for an algorithm that reduces the energy consumption needed for the visual content is obtained through a user interface providing means for adjusting a value, such as a slider, a checkbox, a button, or a combination of several of these elements.

A fifth aspect is directed to non-transitory computer readable medium containing comprising instructions which, when the program is executed by a computer, cause the computer to carry out the described embodiments related to the first or the second aspect.

A sixth aspect is directed to a computer program comprising instructions which, when the program is executed by a computer, cause the computer to carry out any of the described embodiments or variants related to the first or the second aspect.

The above presents a simplified summary of the subject matter to provide a basic understanding of some aspects of the present disclosure. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description provided below.

### BRIEF SUMMARY OF THE DRAWINGS

The present disclosure may be better understood by consideration of the detailed description below in conjunction with the accompanying figures in which:

FIG. 1 illustrates a block diagram of an example of display device in which various aspects and embodiments are implemented.

FIG. 2 illustrates the normalized response spectra of human retina cones (or spectral sensitivity functions).

FIG. 3A illustrates examples of transformation of colors into complementary colors according to the method of spatially alternating complementary colors.

FIG. 3B illustrates examples of replacement of a pixel by a pair of pixels according to the method of spatially alternating complementary colors.

FIG. 4A illustrates the temporal contrast sensitivity function for various adapting fields.

FIG. 4B illustrates the modulation sensitivity as a function of frequency for luminance and chromatic flicker.

FIG. 5A illustrates examples of transformation of colors into complementary colors according to the method of temporally alternating complementary colors.

FIG. 5B illustrates examples of replacement of a pixel by a pair of pixels according to the method of temporally alternating complementary colors.

FIG. 6 illustrates an example of architecture for controlling the balance between energy consumption reduction and quality of experience according to embodiments.

FIG. 7 illustrates an example process for controlling the balance between energy consumption reduction and quality of experience according to embodiments.

FIG. 8 illustrates different examples of user interfaces for selecting an algorithm strength to control the balance between energy consumption reduction and quality of experience according to embodiments.

FIG. 9A illustrates the notion of indistinguishable colors represented by MacAdam ellipses for one of MacAdam's test participant.

FIG. 9B illustrates an example of correspondence between the strength of the algorithm and the radius of a color similarity volume ΔEmax according to embodiments.

FIG. 10A illustrates an example of process for establishing the pair candidates of alternating complementary colors according to a first embodiment.

FIG. 10B illustrates examples of colors selected according to the first embodiment.

FIG. 10C illustrates examples of colors selected according to a second embodiment.

FIG. 10D illustrates an example of process for establishing the pair candidates of alternating complementary colors according to the second embodiment.

FIG. 11 illustrates an example of process for reducing the energy consumption for a pixel of an image using alternating complementary colors according to embodiments.

FIG. 12 illustrates an example of process for associating a pair of alternating complementary colors to an input color according to embodiments.

It should be understood that the drawings are for purposes of illustrating examples of various aspects, features and embodiments in accordance with the present disclosure and are not necessarily the only possible configurations. Throughout the various figures, like reference designators refer to the same or similar features.

### DETAILED DESCRIPTION

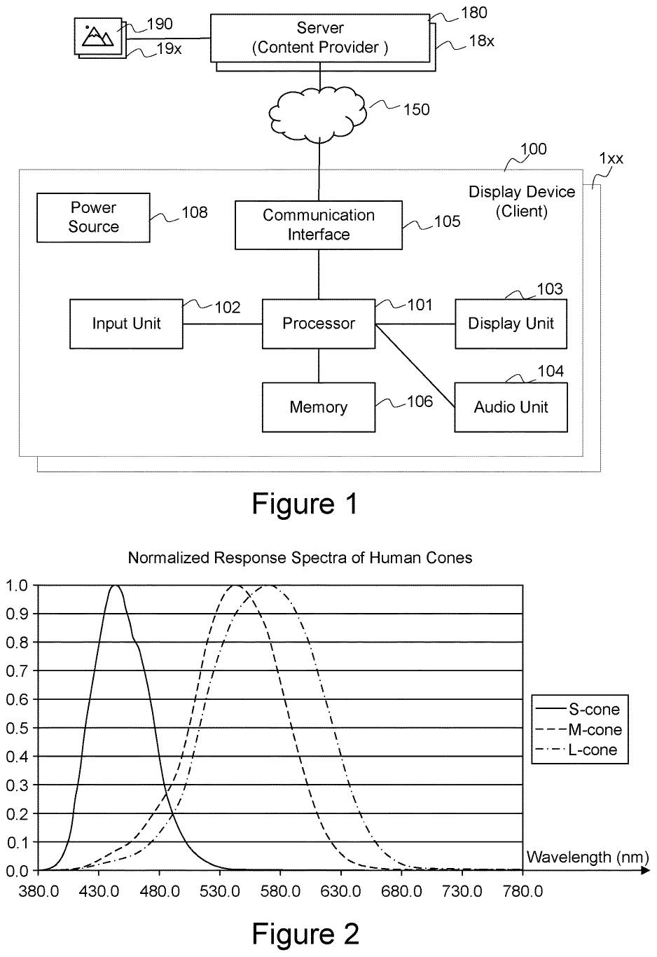

FIG. 1 illustrates a block diagram of an example of display device in which various aspects and embodiments are implemented. In the depicted environment, a user interacts with the display device 100, for example a television, that is connected to a server 180 for example operated by a content provider. The server 180 delivers multimedia content 190 such as video streams based on images. In a video distribution system, multiple devices 100, 1xx are interacting with multiple content providers and corresponding servers 180, 18x delivering multiple multimedia content 190, 19x. A single content provider may use a plurality of servers. The devices exchange data through a communication network 150.

The communication network 150 preferably uses a communication standard to provide interoperability between content provider and display devices. Such communication standard may be wireless, such as cellular (e.g., LTE) communications, Wi-Fi communications, and the like, to ensure the mobility of the display device. Cable, satellite or terrestrial digital television broadcast communication may also be used for the communication network 150 as well as broadband television communications. Such digital television standards may on based on well-established standards like DVB, ATSC, or the like. General purpose network standards may also be used, for example based on Ethernet.

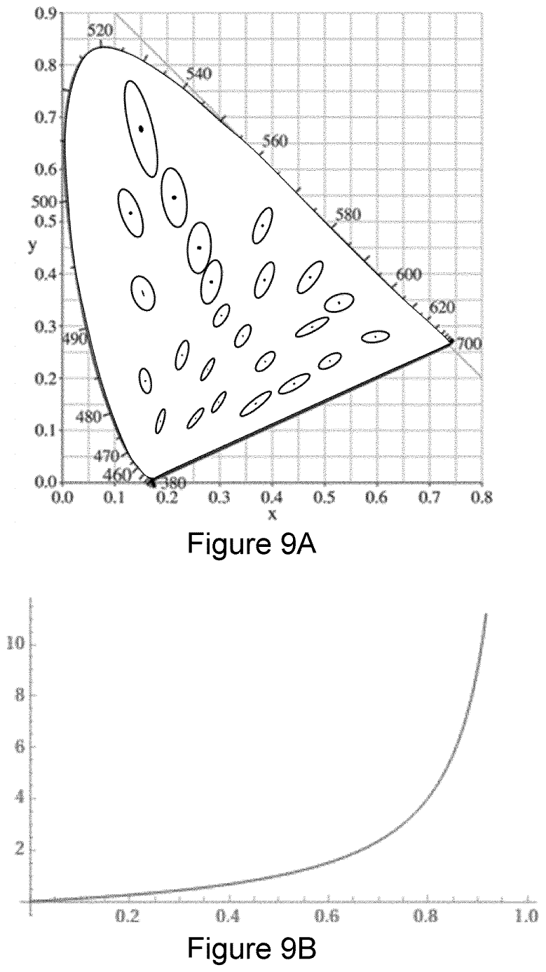

The display device 100 comprises a processor 101. The processor 101 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as the process 700 for controlling the energy consumption reduction of devices displaying a visual content of FIG. 7.

The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still pictures or video in two dimensions or a more complex sensor able to determine the depth information in addition to the picture or video and thus able to capture a complete 3D representation.

The processor 101 may be coupled to a display unit 103 configured to output visual data to be displayed on a screen. Multiple types of displays can be used for that purpose such as a liquid crystal display (LCD) or organic light-emitting diode (OLED) display unit. The processor 101 may also be coupled to an audio unit 104 configured to render sound data to be converted into audio waves through an adapted transducer such as a loudspeaker for example.

The processor 101 may be coupled to a communication interface 105 configured to exchange data with external devices. The communication preferably uses a wireless communication standard to provide mobility of the display device, such as cellular (e.g., LTE) communications, Wi-Fi communications, and the like.

The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 is configured to execute an image energy reduction algorithm that modifies an input image into an image that requires less energy when being used, for example displayed, in comparison to using the input image. Different techniques have been disclosed to provide such feature.

The processor 101 may receive power from the power source 108 and may be configured to distribute and/or control the power to the other components in the device 100. The power source may be any suitable device for powering the device. As examples, the power source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated together in an electronic package or chip. It will be appreciated that the display device 100 may include any sub-combination of the elements described herein while remaining consistent with the embodiments described hereafter. The processor 101 may further be coupled to other peripherals or units not depicted in FIG. 1 which may include one or more software and/or hardware modules that provide additional features, functionality and/or wired or wireless connectivity. For example, the peripherals may include a universal serial bus (USB) port, a vibration device, a television transceiver, a hands-free headset, a Bluetooth® module, a frequency modulated (FM) radio unit, a digital music player, a media player, a video game player module, an Internet browser, and the like. For example, the processor 101 may be coupled to a localization unit configured to localize the display device within its environment. The localization unit may integrate a GPS chipset providing longitude and latitude position regarding the current location of the display device but also other motion sensors such as an accelerometer and/or an e-compass that provide localization services.

In at least one embodiment, the processor 101 of the display device 100 is configured to display on the display unit 103 an image according to embodiments described further below. In a first variant embodiment, the image 190 is obtained from the content provider server 180 through the communication network 150. In a second variant embodiment, the image is obtained from the memory 106, stored for example after being captured by the input unit 102 or being transferred from a server.

Typical examples of device 100 are smartphones, tablets, laptops, monitors, head-mounted displays, television sets, video projectors, computer screens, vehicles (e.g., control and/or entertainment systems for cars, planes, boats, etc.), advertisement display panels, medical monitors, etc. However, any device or composition of devices that provides similar functionalities can be used as display device 100 while still conforming with the principles of the disclosure.

In at least one embodiment, the device does not include a display unit but prepares data representative of an energy-reduced visual content so that another device can utilize the energy-reduced visual content for further processing. In at least one embodiment, such device prepares data to be displayed by another device such as a screen. Examples of such devices are set top boxes, media players, desktop computers, encoders, decoders, servers, computing grids, cloud computers, etc.

At least one example of an embodiment can involve a device including an apparatus as described herein and at least one of (i) an antenna configured to receive a signal, the signal including data representative of the image information, (ii) a band limiter configured to limit the received signal to a band of frequencies that includes the data representative of the image information, and (iii) a display configured to display an image from the image information.

At least one example of an embodiment can involve a device as described herein, wherein the device comprises one of a television, a television signal receiver, a set-top box, a gateway device, a mobile device, a cell phone, a tablet, a computer, a laptop, or other electronic device.

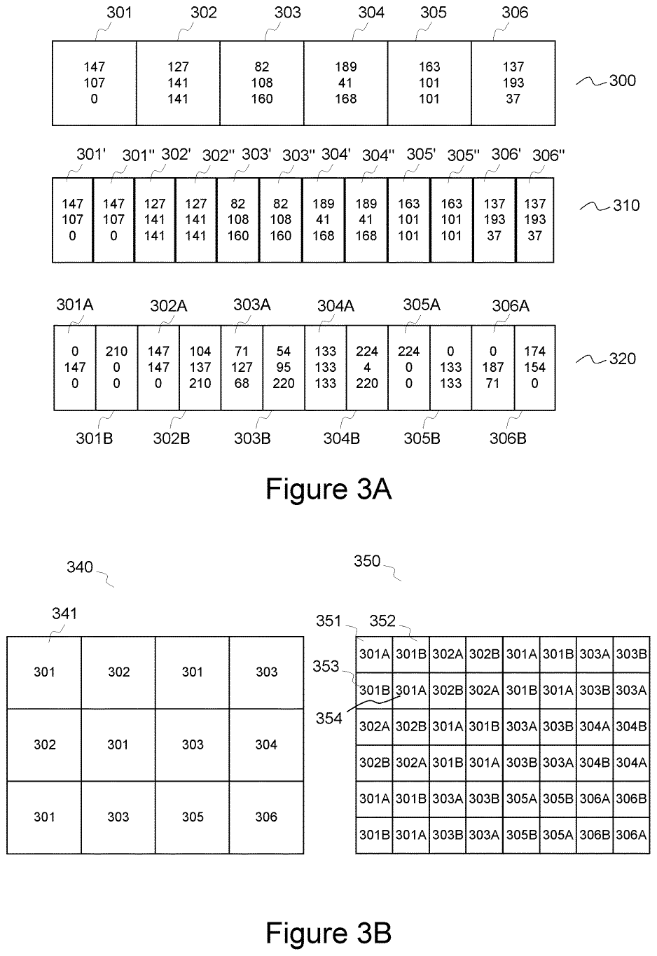

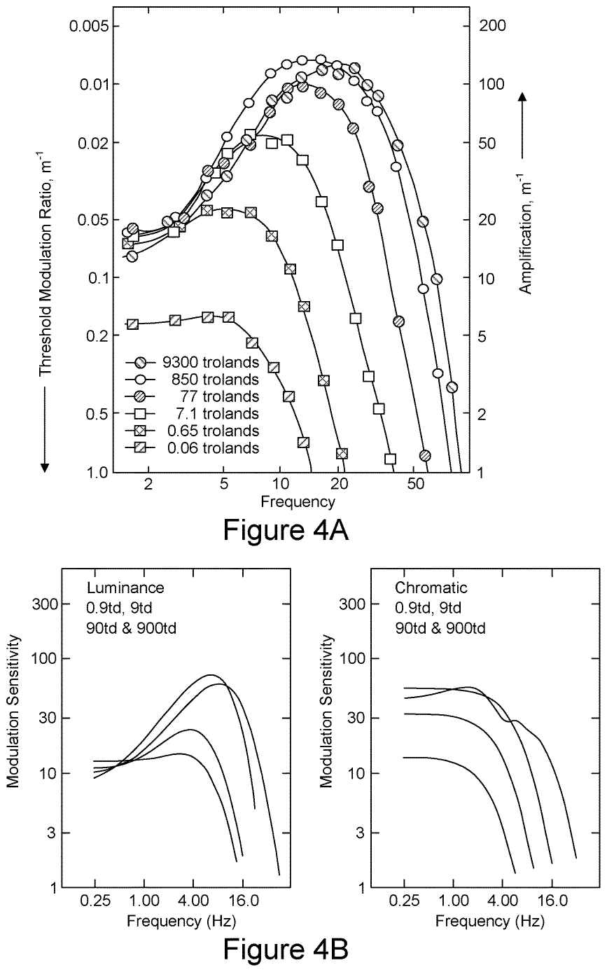

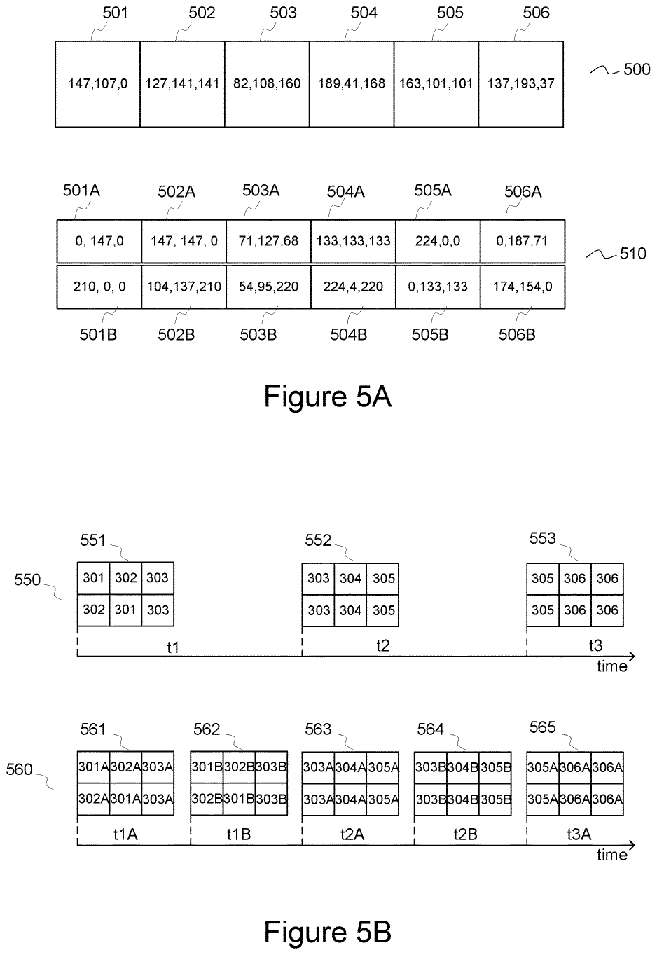

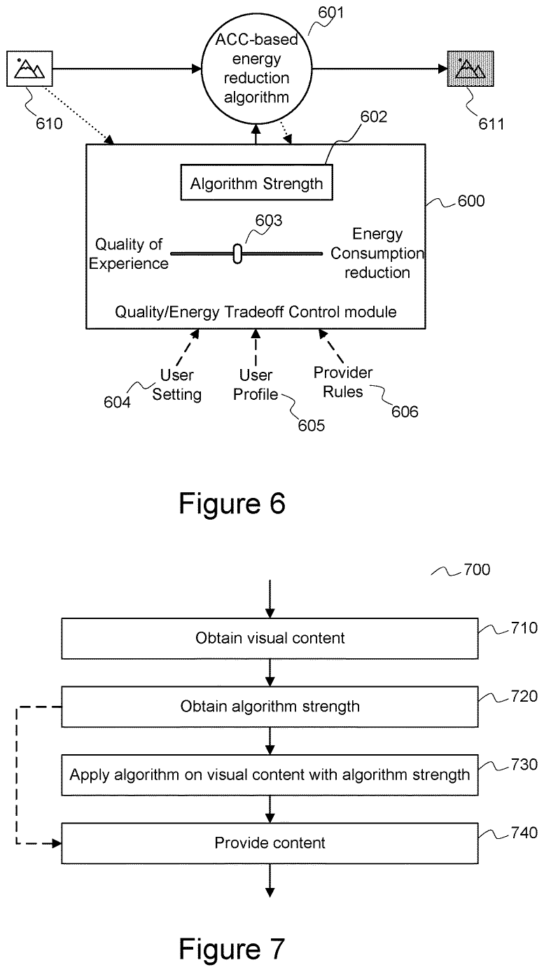

Two techniques allow to minimize the energy consumption when displaying (or more generally when using) an image. These techniques are based on using alternating complementary colors to modify an image so that it requires less energy. The first technique modifies the image through a spatial alternating arrangement (FIGS. 2, 3A, 3B) and the second uses a temporal alternating arrangement (FIGS. 4A, 4B, 5A, 5B).

FIG. 2 illustrates the normalized response spectra of human retina cones (or spectral sensitivity functions). Electromagnetic radiation is characterized by its wavelength (or frequency) and its intensity. The range of wavelengths humans can perceive is approximately from 380 nm to 780 nm. When the wavelength is within this range, it is known as “visible light”. Perception of color is based upon the varying sensitivity of different cells in the retina (color receptors: cones and rods) to light of different wavelengths. Human observers have three types of color receptors, known as cone cells. This confers trichromatic color vision, cones being usually labeled either according to the wavelengths of the peaks of their spectral sensitivities: short(S), medium (M), and long (L), or simply according to the primary colors those peaks are centered on: Blue, Green, or Red as illustrated in FIG. 2.

Trichromatic theory teaches us that the color a human observer perceives of a light spectrum can be characterized by 3 single scalar values. From a mathematical point a view, this initial step of human vision could be compared to that of a triple-kernel energy computation process. Let si(λ) be the wavelength response of a given light spectrum, and l(λ), m(λ), and s(λ) be respectively the spectral sensitivity functions of the L, M, and S cones, equation 1 below defines Li, Mi, and Si. These are the 3 scalar values that characterize the color of spectrum si(λ) seen by a human observer.

$${L}_{i} = {{\int }_{- ∞}}^{+ ∞} {s}_{i} ( λ ) \cdot l ( λ ) d λ \qquad ( 1 )$$

$${M}_{i} = {{\int }_{- ∞}}^{+ ∞} {s}_{i} ( λ ) \cdot m ( λ ) d λ$$

$${S}_{i} = {{\int }_{- ∞}}^{+ ∞} {s}_{i} ( λ ) \cdot s ( λ ) d λ$$

Although the spectrum of light reaching the eye from a given direction determines the color sensation in that direction, there are many more possible spectral combinations that result in the same color sensations. In colorimetry, the term metamerism refers to the matching of a same apparent color of light signals with different spectral power distributions. Color spectra that match this way are called metameric spectra. Based on Equation (1), the mathematical definition of metamerism would be ∀λ∈R:

$$∃ λ ∈ [ 380 , 780 ] \cdot {s}_{1} ( λ ) \neq {s}_{2} ( λ ) \qquad ( 2 a )$$

$${\int }_{- ∞}^{+ ∞} {s}_{1} ( λ ) \cdot l ( λ ) d λ = {\int }_{- ∞}^{+ ∞} {s}_{2} ( λ ) \cdot l ( λ ) d λ \qquad ( 2 b )$$

$${\int }_{- ∞}^{+ ∞} {s}_{1} ( λ ) \cdot m ( λ ) d λ = {\int }_{- ∞}^{+ ∞} {s}_{2} ( λ ) \cdot m ( λ ) d λ \qquad ( 2 c )$$

$${\int }_{- ∞}^{+ ∞} {s}_{1} ( λ ) \cdot s ( λ ) d λ = {\int }_{- ∞}^{+ ∞} {s}_{2} ( λ ) \cdot s ( λ ) d λ \qquad ( 2 d )$$

where s1(λ) and s2(λ) are the spectral compositions of two metameric (yet different) spectra.

The term spatial resolution refers to the distance between independent measurements, or the physical dimension that represents a pixel of an image. It is thus the distance between two adjacent pixels of a displayed image. Visual acuity of human eye limits the spatial resolution that the visual system can process. According to various studies performed, human visual system can discern spatial differences of ~0.6 arcminutes. As 1′×T/(60×180)=0.0002909 rad, 0.6 arcminutes=0.0001745328 rad. Above a given viewing distance, two adjacent pixels cannot be resolved, they are perceived as a single pixel. The luminous power from the various subpixels is summed up and this gives the apparent continuity of images as seen on a screen. This is the notion of spatial fusion. Embodiments described herein are designed to benefit from the visual fusion of the human visual system and more particularly, the unification of visual excitations from the corresponding retinal images of adjacent pixels into a single visual percept. For example, the usual viewing distance for a mobile phone screen is 25-30 cm. So, if the distance between two-point size light sources is less than 0.044-0.052 mm, they will appear as single source. For a TV screen, if the distance between two-point size light sources is less than 0.52 mm, they will typically appear as single source.

At least one technique uses these principles to determine a pair of colors that, when being spatially combined, is perceived by a human observer as another (single and stable) color. Indeed, the technical effect used herein relies on the visual fusion characteristic of the human vision system. In other words, when visualizing a display of spatially alternating complementary colors, the human visual system perceives a single corresponding color that visually has the same perceptual characteristics.

Therefore, the high-level principle of a first technique to minimize the energy consumption can be considered as adding a dimension to the image signal by replacing a color by two visually complementary colors, the two colors being arranged spatially. The two adjacent pixels of spatially alternating complementary colors would be perceived by the user as a single pixel with maximal visual similarity. This principle is herein named spatially alternating complementary colors (SACC).

A first technique to reduce the energy needed to display the modified pixels on a display device is based on modifying a pair of color pixels using SACC while preserving as much as possible the visual similarity with the original pair of pixels and quality of experience. Such methods exploit the principle of visual and spatial fusion and propose to set the colors of a pair of adjacent pixels of the image to a pair of spatially alternating complementary colors requiring less energy for display. A pair of spatially alternating complementary colors is selected so that the average color of the pair of colors is perceptually identical to an input color or an average of input colors and the energy of the pair of colors is lower than the energy of the input color. The term “energy of the color” should be understood here as the energy needed for rendering a pixel of the color. Different types of spatial replacement are described: pixel doubling, pixel skipping and pixel averaging.

A first method for SACC is based on pixel doubling (it may also be understood as pixel splitting). In other words, the number of pixels of an input image is doubled to create a couple of adjacent pixels, either in width only or in height only or in both dimensions, thus adding new “duplicated” pixels forming the second half of the pair of adjacent pixels. A pixel of the original image is replaced by two pixels of same color (thus the notion of splitting). The pair of adjacent pixels (an original pixel and a duplicated pixel) is then replaced by a pair of pixels of spatially alternating complementary colors, in other words, the pair of spatially alternating complementary colors are assigned to the adjacent pixels. In the case where the original content sent to a display is of a lower resolution than the resolution of the display, some internal upsampling is usually undergone inside the display itself. In such case, this upsampling may be replaced by this first method based on pixel doubling which implicitly uses an upsampled resolution.

A second method for SACC is based on pixel skipping where one pixel over two is set free by cancelling the content initially displayed on it, and the pair of spatially alternating complementary colors is determined based on the color of the first pixel of each adjacent pair of pixels of the original image only, thus no more taking into account the color of the second pixel of the original pair. This allows to set the colors of an original pair of adjacent pixels by a pair of spatially alternating complementary colors: the first pixel of the original pair being assigned the first color of the pair of spatially alternating complementary colors, and the second pixel of the original pair being assigned the second color of the pair of spatially alternating complementary colors.

A third method for SACC is based on pixel averaging where the pair of spatially alternating complementary colors is determined based on an average color computed from the colors of the first and second pixels of a couple of adjacent pair of pixels of the original image. The first pixel of the original adjacent pair is assigned the first color of the pair of spatially alternating complementary colors and the second pixel of the original adjacent pair is assigned the second color of the pair of spatially alternating complementary colors. Unlike the second method based on pixel skipping, this method takes into account the colors of all the pixels of the original image or video.

For all three methods, different arrangements of adjacent pixels can be used, for example based on stripe patterns, mosaic patterns or random patterns.

The notion of adjacent pixel is introduced above to facilitate the understanding. However, the three SACC methods described above share the same principle of replacing an input pixel of an input color by a couple of pixels of spatially alternating complementary colors.

FIG. 3A illustrates examples of transformation of colors into complementary colors according to the method of spatially alternating complementary colors. In this figure, the line 300 corresponds to an extract of an original image and represents a line of pixels 301 to 306. The three numbers inside each block correspond to the color of the corresponding pixel, represented by RGB values expressed using an 8-bit depth. For example, the first pixel 301 is defined by the following values for the color components of the pixel: 147 for red, 107 for green and 0 for blue. This results in a brown pixel. The colors of the other pixels are respectively medium grey for second pixel 302, navy blue for the third pixel 303, dark magenta for the fourth pixel 304, reddish brown for the fifth pixel 305, and bright green for the sixth pixel 306.

The figure illustrates a method based on pixel doubling in horizontal direction. For that, it is necessary to duplicate the pixels 301 to 306, thus leading to the line 310 where for example the pixel 301 is duplicated into pixels 301′ and 301″. In this method, the pixels whose color is to be replaced are horizontally adjacent, in other words, the pixels 301′ and 301″ for a pair of adjacent pixels, the next pair is 302′ and 302″, and so on up to the pair 306′ and 306″.

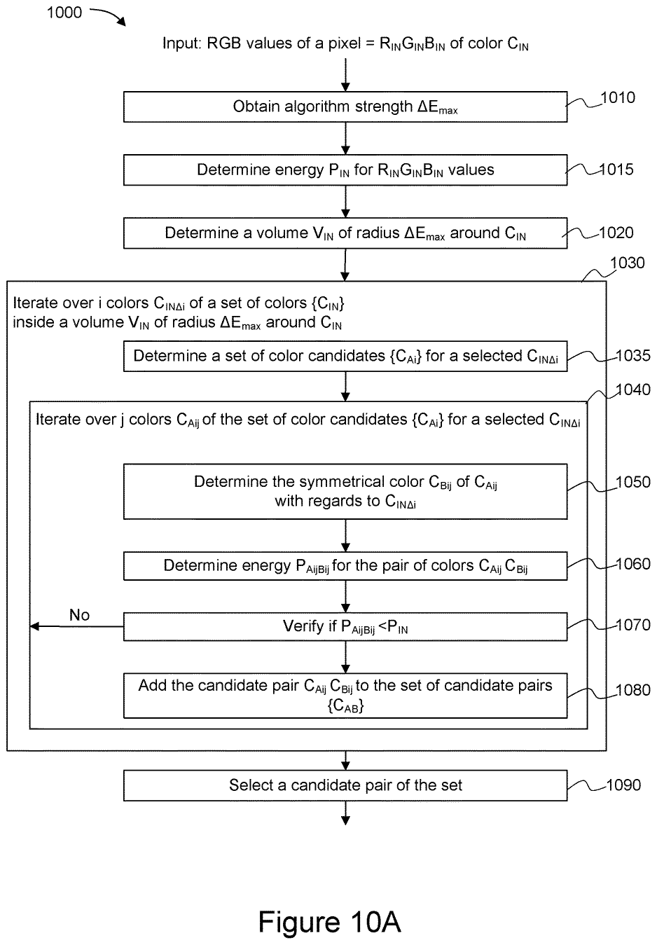

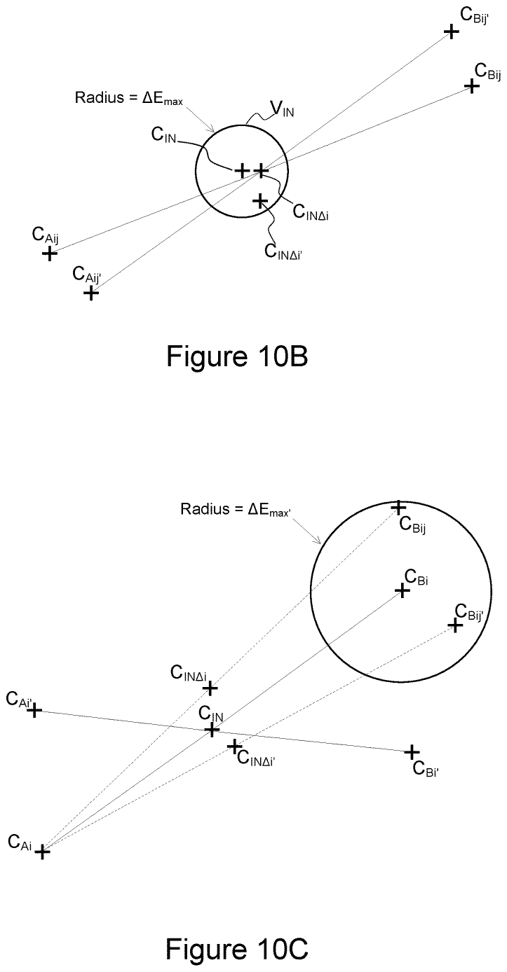

Line 320 shows a set of pairs of pixels (301A, 301B to 306A, 306B) having spatially alternating complementary colors and used to replace the original pixels 301 to 306. Similar to line 300, the values inside the blocks represent the colors of the pixels. Thanks to the spatial fusion of the human visual system, the spatial arrangement of the green pixel 301A and the red pixel 301B is perceived by a human observer as a brown pixel identical in perceived color to pixel 301, or more generally to the combination of pixels 301′ and 301″. A complete example is described below in relation with FIG. 3B. In other methods, for example when increasing the image resolution is not possible, other techniques are used, such as pixel skipping or pixel averaging. Examples of such methods are described below in relation with FIGS. 8A, 8B and 9.

FIG. 3B illustrates examples of replacement of a pixel by a pair of pixels according to the method of spatially alternating complementary colors. In the figure, the array 340 represents an example of an original (i.e., before being modified) image to be displayed, here comprising three rows of four pixels each (for the sake of simplicity of the drawings). Each pixel is represented by a rectangle comprising a color value according to the colors defined in FIG. 3A. For example, the pixel 341 in the upper left corner is a brown pixel. In a first variant of such method (not illustrated), the width is doubled compared to the original image. For example, if the input image would have a resolution of 1920 by 1080 pixels, the modified image where the original pixels would be replaced by spatially alternating complementary color pixels would have a resolution of 3840 by 1080 pixels. In a second variant of such method (not illustrated), the height is doubled compared to the original image. For example, if the input image would have a resolution of 1920 by 1080 pixels, the modified image where the original pixels would be replaced by spatially alternating complementary color pixels would have a resolution of 1920 by 2160 pixels.

In a third variant of such method as illustrated in the figure, both the width and the height are doubled compared to the original image. For example, if the input image would have a resolution of 1920 by 1080 pixels, the modified image where the original pixels would be replaced by spatially alternating complementary color pixels would have a resolution of 3840 by 2160 pixels. In other words, each pixel would be replaced by a set of four pixels of two spatially alternating complementary colors. The array 350 represents an image based on the original image of array 340 and modified according to this third variant. The processor first inserts additional columns (second, fourth, sixth and eight columns) and lines (second, fourth, sixth and eight lines) to create duplicate pixels. Then the processor selects a first pair of adjacent pixels, for example the horizontal pair of pixels 351 and 352. From the color (301) of the first pixel 301A of the first pair of adjacent pixels, the processor determines a pair of spatially alternating complementary colors (301A, 301B) that, when combined, look identical in perceived color to the original color 301 but require less energy for its display. This process may use a table storing an association between a color and a pair of colors looking similar in perceived color but requiring less energy. These colors are then used to set the colors of the pair of adjacent pixels. As a result, the color of pixel 351 is set to 301A while the color of pixel 352 is set to 301B. The process is iterated over all pairs of adjacent pixels in both the horizontal and the vertical directions. The result is a modified image, whose pixels have the value of the array 350, that looks identical to the original image 300 but requires less energy for its display when displayed on a screen. For example, the brown pixel 341 is replaced by four pixels 351, 352, 353, 354 of respective colors values 301A (green), 301B (red), 301B (red) and 301A (green). The determining of the pair of spatially alternating complementary colors corresponding to the color 301 of original pixel 341 needs to be done only once. It results on the pair (301A, 301B) that is applied onto the 4 pixels 351, 352, 353, 354 in a mosaic arrangement (i.e., changing the order between the colors of the pair for the second line) to provide a good distribution of the colors.

The first and second variants may be implemented internally in a display panel by physically doubling the number of pixels in one of the directions but without providing access to the additional pixels to the outside world. The third variant is of more general use. Indeed, the resolution of content currently available is often inferior to the capabilities of the display device. It is quite common to have a full HD content (1920×1080) displayed on a UHD-capable (3840×2160) or 4K-capable (4096×2160) device. Therefore, this technique could be considered as a simple upscaling function that while providing the additional pixels for the upscaling also provides a reduction of the energy required for displaying the upscaled image.

In the description of these methods, the first pixel of a pair of pixels is always replaced by the first color of the pair of spatially alternating complementary colors. In at least one variant method, an alternance is introduced between lines (respectively columns) regarding the order of selection of the pair of colors. In a first line (respectively column), the color of the first pixel of a pair of pixels is replaced by the first color of the pair of spatially alternating complementary colors and the color of the second pixel of a pair of pixels is replaced by the second color of the pair of spatially alternating complementary colors but in the second line (respectively column), the color of the first pixel of a pair of pixels is replaced by the second color of the pair of spatially alternating complementary colors and the color of the second pixel of a pair of pixels is replaced by the first color of the pair of spatially alternating complementary colors.

A second technique to minimize the energy consumption uses temporally alternating complementary colors to modify an image. This second technique is based on the principles described in relation with FIG. 2 and the principles described hereafter in FIGS. 4A and 4B.

FIG. 4A illustrates the temporal contrast sensitivity function for various adapting fields. In the spatial domain, spatial vision can be characterized by the contrast sensitivity function (CSF). To thoroughly investigate the visual system sensitivity to flicker, a Temporal Contrast Sensitivity Function (TSF) or a De Lange function can be plotted (De Lange, 1958). A TSF is a plot of how flicker varies with contrast and vice versa. In this figure, the area above the curve represents the area where no flicker is perceived by a human observer and the area below the curve represents the area where flicker is perceived. The eye appears to be most sensitive to a flicker frequency of 15 to 20 Hz at higher luminances (photopic vision). At photopic light levels, less than 1% contrast is required to detect the stimulus and the high temporal frequency cut off is close to 60 Hz. At lower light levels the maximum contrast is about 20% and the high temporal frequency cut off is approximately 15 Hz. To detect flicker of high frequencies, maximum contrast is required. Temporal resolution is not as efficient at low luminances (scotopic vision).

FIG. 4B illustrates the modulation sensitivity as a function of frequency for luminance and chromatic flicker. In this figure, the luminance levels are measured in trolands (td) that characterize retinal illuminance. This figure was obtained by psychovision studies, in a typical application of Heterochromatic Flicker Photometry (HFP). The participants viewed a stimulus that alternated rapidly in time between two lights of different colors; the participant then had to adjust the intensity of one of the two lights (i.e., the amplitude of the light's spectrum) to minimize the sensation of flicker produced by the alternating lights. The figure on the left side is related to luminance flicker while the figure on the right side is related to chrominance flicker. HFP has long been the standard psychophysical method for finding equiluminant colors.

While the SACC technique previously described is based on spatial fusion, another technique, hereafter named Temporal Alternating Complementary Colors (TACC) is based on temporal fusion. The principles illustrated in FIGS. 5A and 5B are used to determine a pair of colors that, when being temporally combined, are perceived by a human observer as another (single and stable) color. The technical effect used herein relies on temporal psychovisual modulation and the existence of a maximum cutoff frequency in the flicker sensitivity of human eye. Therefore, the high-level principle of TACC can be considered as adding a dimension to the image signal by temporally duplicating each pixel into two visually complementary temporally successive pixels and using this added dimension to minimize the pixel equivalent energy consumption. The two temporally successive pixels would be perceived by the user as a single pixel if the alternance between these pixels is faster than the flicker fusion frequency.

Normal flicker fusion frequency is about 50 Hz to 60 Hz and depends on retinal illumination. However, sensitivity to flicker in equiluminance situations is smaller (20 Hz to 30 Hz) than in situations where luminance varies between the two images of a pair. Then with the additional specific condition that the difference in luminance between two colors is small enough, flicker caused by the alternation of two colors is minimal. This equiluminant condition, mixed with the basic colors alternance configuration, can be used to limit the visibility of flicker.

FIG. 5A illustrates examples of transformation of colors into complementary colors according to the method of temporally alternating complementary colors. In this figure, the line 500 shows a succession of pixels 501 to 506. The three numbers inside each block correspond to the color of the corresponding pixel, represented by RGB values expressed using an 8-bit depth. For example, the first pixel is defined by the following values for the color components of the pixel: 147 for red, 107 for green and 0 for blue. This results in a brown pixel. The colors of the other pixels are respectively medium grey for second pixel 502, navy blue for the third pixel 503, dark magenta for the fourth pixel 504, reddish brown for the fifth pixel 505, and bright green for the sixth pixel 506.

Line 510 shows a set of pairs of temporally successive pixels (501A, 501B) to (506A, 506B). These pairs of temporally successive pixels correspond to the alternating complementary colors that could be used to replace the original pixels 501 to 506. Similar to line 500, the values inside the blocks represent the colors of the temporally successive pixels. In one example method, the temporally successive pixels are half the duration of the original pixels. In other words, a first image frequency (for instance 60 Hz) is doubled into a second image frequency (for instance 120 Hz) and an input image is decomposed into an output image pair displayed at the second image frequency. For example, the pixel 501 displayed in the input image at a frequency of 60 Hz could be replaced by the succession of the pixels 501A (green pixel) and 501B (red pixel) displayed at a global frequency of 120 Hz. The succession of the green and red pixels is perceived by a human observer as a brown pixel, thanks to the heterochromatic flicker fusion. A complete example is described below in relation with FIG. 5B.

FIG. 5B illustrates examples of replacement of a pixel by a pair of pixels according to the method of temporally alternating complementary colors. In this method based on frame doubling, the display frequency is doubled compared to the original image frequency. For example, if the sequence of images was intended to be displayed at 50 Hz, the display frequency is doubled to display a sequence of modified images at 100 Hz, allowing to replace the original pixels by alternating complementary color pixels and thus allowing to reduce the energy consumption of the display while preserving the quality of experience.

In the figure, the line 550 represents a temporal sequence of original (i.e., before being modified) images to be displayed, here comprising three images 551, 552, and 553. These images are displayed respectively during the periods t1, t2 and t3. In the example of a 50 Hz display frequency, the length of these periods is 20 ms. For the sake of simplicity of the drawings, the images 551, 552, and 553 are composed of 2 rows of three pixels each. The pixels are represented here by numbered blocks. The number identifies the pixel color with reference to the colors introduced in FIG. 5A. For example, the first line of image 551 is composed of pixels 301, 302, and 303. Therefore, the first pixel 301 of this line is brown with RGB value of 147, 107, 0, the second pixel 302 is navy blue with RGB values of 127, 141, 141, and the third pixel 303 is dark magenta with RGB values of 82, 108, 160. In the second line, the three pixels are respectively navy blue, brown and dark magenta.

The line 560 represents a temporal sequence of the modified image to be displayed, comprising images 561, 562, 563, 564, and 565. Each of these images is displayed for half the duration compared to the line 550, in correspondence with the frequency doubling. Therefore, the initial 50 Hz display frequency for line 550 is doubled to 100 Hz in line 560 and the periods t1A, t1B, t2A, t2B and t3A are 10 ms long. Compared to line 550, a double number of images are displayed in line 560. This allows to insert intermediate images to introduce the alternating complementary color pixels, thus allowing to reduce the energy consumption when displaying the image.

For each pixel of the original image 551, a color pair is determined as described earlier in relation to FIG. 5A. This color pair is used to define a first pixel of the first color of the color pair for image 561 and a second pixel of the second color for image 562, the two pixels being displayed successively at the double frequency of the expected display of the original pixels. For example, the brown pixel 301 of image 551 is replaced by a green pixel 301A in image 561 and a red pixel 301B in image 562. These replacement red and green pixels are displayed half the time of the original brown pixel. As described previously, thanks to the human visual system color fusion, these pixels will be perceived by a human viewer as having the brown color of pixel 301, while requiring less energy for their display.

The frame doubling mechanism for pixel replacement by alternating complementary color pixels has been presented in FIG. 5B when applied to a sequence of images, in other words, a video. However, the same principle applies when displaying a single static image (e.g., text edition application on a computer screen content, configuration screen on a tablet, email application on a smartphone, static image on an advertisement screen, etc.). In this case, the FIG. 5B would be restricted to the elements related to image 551 (the single image to be displayed) and the images 561 and 562. Instead of conventionally displaying the image 551 at a given frequency, the images 561 and 562 would be displayed in alternance at a double frequency.

In other methods, for example when doubling the display frequency is not possible, other techniques are used to replace a color by a pair of colors, such as frame skipping or frame averaging. For both techniques, referring to FIG. 5B, the original video would display a second image during t1 between the image 551 and the image 552. The frame skipping method simply discards this second image so that the same principles than the frame doubling technique described above apply. The frame averaging method also discards this second image but before that, the values of pixels of the image 551 are replaced by the average values of pixels of the image 551 and of the discarded image. After that step, the same principles than the frame doubling technique described above apply.

Both the SACC and TACC techniques are based on an association between an input color and a pair of replacement colors. This association is determined by selecting the pair of colors that satisfies two conditions: visual identity and energy reduction. The first condition is that the average of the colors of a couple of pixels of the pair of replacement colors in a SACC or TACC modified image is equal to the level of the color of a pixel of the input color in the input image. This means that the pair of replacement pixels will be perceived by a viewer as identical to the input pixel. The second condition is that the energy needed to display the pair of replacement colors in a SACC or TACC modified image is lower than the energy needed to display the input color. In practice, this is not feasible for every input pixel, which can lead to a tradeoff between quality of experience and energy reduction. In an optimal implementation of SACC or TACC, the color pair chosen is the pair that provides the highest energy reduction. With both of these techniques, the user has no way to control the balance between quality of experience and energy reduction.

In video broadcast, the constraint is often set that the image displayed on the user's screen should show as little degradation as possible for a given transmission and display environment. While an absolutely high-quality requirement is understandable for featured movies or programs with a high artistic value, many other program types, like weather forecast, TV games, cartoons, or advertisements for example, do not need an absolutely crisp quality. At least this is not a need for all users and reducing quality on selected program types is a possibility for many of them, specifically if there is a gain in energy.

The SACC and TACC image processing algorithms are both designed to replace a color by a pair of colors providing energy reduction with the goal of preserving the visual identity toward the initial color. These techniques favor the quality of experience since the average color of a pair of replacement colors for an input color is perceptually identical to the input color. From the point of view of quality of experience, the SACC and TACC algorithms have the capacity to be invisible or flawless. They provide an energy reduction, at a given level depending on the images. This energy reduction may be fair, sometimes small, or modest. The impact on the energy reduction is therefore done in a “best effort” mode since depending on the values of the pixels of the image: selecting, among a list of color pairs being visually identical, the pair with the lowest energy consumption. This is also true for other energy reduction techniques: in general, the objective of such techniques is primarily to minimize the energy consumption of visual media presentation or display, on TV sets or on mobile displays while maintaining the QoE (Quality of Experience) of the visual media presentation.

However, users may find it acceptable to relax this constraint of optimal visual similarity and to accept a lower visual quality if they are rewarded by higher gain in terms of energy savings. For that reason, it is proposed herein to introduce control means for the user to balance the quality of experience against the consumed energy. In other words, allowing the user to select the strength of the algorithm used to select the replacement colors for the spatially and temporally alternating complementary colors techniques.

For these spatially and temporally alternating complementary colors replacement algorithms, a parameter hereafter named Algorithm Strength (AS) acts on the level of energy reduction in link with the quality (similarity) level. Algorithm Strength is, in practice, a parameter in the algorithm performing the image modification for energy reduction, such that, depending on this Algorithm Strength, different and continuous energy reduction levels are reached and a corresponding QoE is obtained. More particularly, the AS parameter impacts a distance in a color space (parameter ΔEₘₐₓ further detailed below), continuous and allowing to progressively go from no energy reduction to a higher energy reduction. In parallel, QoE will go from invisibility of defects (i.e., no visible defects), to more and more visible defects. In other words, the visual similarity progressively will no longer be identical but will become less similar (or less perceptually close).

When using the spatially alternating complementary colors or the temporally alternating complementary colors techniques, the Algorithm Strength may be defined as following.

The principle of these techniques is to replace a pixel of color C_{IN} by a pair of half pixels (either spatially or temporally) of colors (C_{A}, C_{B}) such that:

$$\frac{1}{2} ( 𝒫 ( {C}_{A} ) + 𝒫 ( {C}_{B} ) ) < 𝒫 ( {C}_{IN} ) ,$$

[symbol] being the power consumed for a color, and such that

$$\frac{1}{2} ( 𝒫 ( {C}_{A} ) + 𝒫 ( {C}_{B} ) )$$

is minimized. In other words:

(C_{Amin},C_{Bmin})=argmin( [symbol] (C_{A})+ [symbol] (C_{B})) such that:

$$\frac{1}{2} ( 𝒫 ( {C}_{A} ) + 𝒫 ( {C}_{B} ) ) < 𝒫 ( {C}_{IN} ) and \frac{1}{2} ( {C}_{A} + {C}_{B} ) = {C}_{IN}$$

in a uniform color space.

However, the minimization could also be adjusted to match a variable request R in energy reduction. To do this, an additional constraint can be added through a multiplicative parameter R: the minimum is identified in a set larger than the initial search set where:

R·( [symbol] (C_{A})+ [symbol] (C_{B}))<( [symbol] (C_{Amin})+ [symbol] (C_{Bmin}))< [symbol] (C_{IN})
where R∈[0.1 [.
   A value of R=0 is equivalent to maximal energy reduction and maximal image modification. This value is never used in practice.
   A value of R=1 is equivalent to minimal (no) energy reduction and minimal (no) image modification.
   values of R between 0 and 1 allow for a gradation in energy reduction and image modification.

Parameter R or a parameter linked to it can for example be directly adjusted by the user, for instance with a remote control, with a widget, a slider or with any type of UI control. The energy saving can be tuned between a minimum effect (no effect) and a maximum effect depending on the user or possibly on another control.

The relationship between Algorithm Strength and the parameter R is the following in the example of a linear case:

AS=1−R
A value of AS=1 is equivalent to maximal energy reduction and maximal image modification.
A value of AS=0 is equivalent to minimal (no) energy reduction and minimal (no) image modification.
Values of AS between 0 and 1 allow for a gradation in energy reduction and image modification.

The relationship between Algorithm Strength and the parameter R can be different, for example non-linear cases as described hereafter in relation with FIG. 9B.

In general, Image/Video Processing Algorithms dedicated to energy reduction tasks may realize their tasks with different degrees of Quality of Experience: they may introduce no defect, or no visible defects; they may also create visible defects of different strength or disturbance for the end user. In case no defect or no visible defect is introduced (“flawless”), there is no need to balance energy reduction with Quality of Experience, as the latter is not modified. On the contrary, when visible defects are introduced, it is desired to give the user access to a way to balance the energy reduction against QoE.

Limiting the Algorithm Strength to the flawless case is the common practice when the reference is the content creators' intent or the broadcasters' choice of highest visual quality. The strength is then often adjusted to satisfy a non-visible degradation objective. In this case, during user tests, a maximum difference of one JND (Just Noticeable Difference) is sought, where one JND is defined as the amount of change in a value of something for a difference to be noticeable, or detectable at least half of the time.

Starting from a conservative strength state with no visible default on average, algorithms may evolve in the direction of stronger energy reduction while producing acceptable flaws. In this case the algorithm Strength is increased. The Algorithm Strength can go up to a level where defects become slightly visible, or more and more visible when the Algorithm Strength increases. However, some defects, even if strong, are possibly acceptable to the end user and their presence can be even more accepted if the users are rewarded e.g., by energy savings.

On this basis, embodiments described below propose to control the balance between energy consumption reduction and quality of experience by controlling the level of the strength of the SACC or TACC algorithms used to perform the energy reduction. With such a system, the users may choose to sacrifice a part of their visual satisfaction with the benefit of consuming less energy. The techniques proposed hereafter introduce the notion of a color similarity volume around a reference color in the color space within which a color is considered acceptable by the user, the radius of this color similarity volume being controlled by the user for example through user interface elements or user setting parameters.

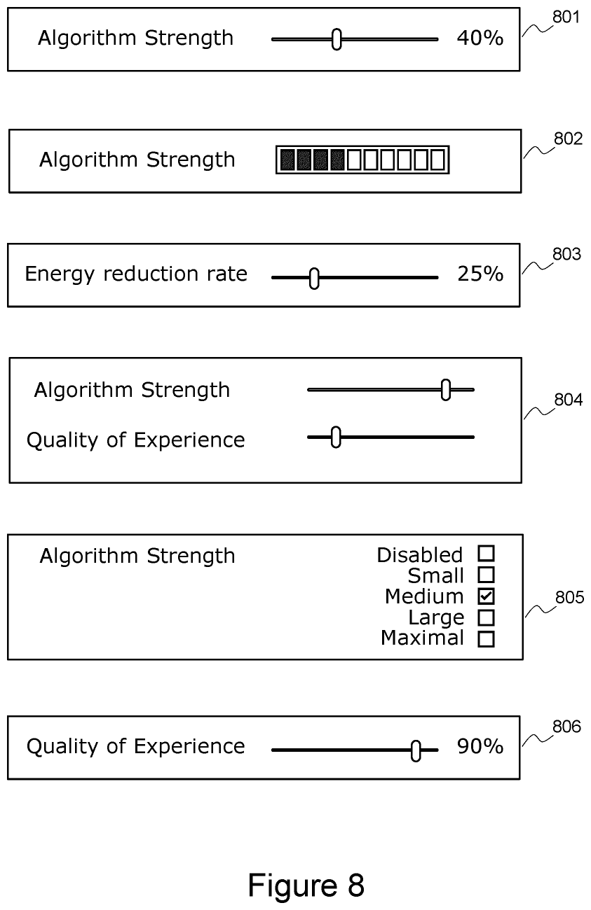

FIG. 6 illustrates an example of architecture for controlling the balance between energy consumption reduction and quality of experience according to embodiments. This architecture is for example implemented by a device such as the device 100 of FIG. 1. The device comprises an image energy reduction algorithm 601 that transforms an input image 610 into a modified image 611 that requires less energy when being used. This algorithm is for example based on temporally alternating complementary colors or spatially alternating complementary colors as described above.

The device comprises a quality/energy tradeoff control module 600 that handles the tradeoff between the quality of experience and the energy consumption reduction when using a visual content. This control is done by setting the appropriate value for the Algorithm Strength 602 that impacts the image energy reduction algorithm. The tradeoff can be adjusted by several inputs comprising for example a user setting 603, a user (or device) profile 605, or content provider rules 606. Information from the algorithm 601 or from the images 610, 611 may also be considered. In at least one embodiment, the algorithm strength value is one minus the energy reduction rate value. For example, for a 20% reduction (0.2 reduction rate), the algorithm strength value is equal to 0.8.

As some defects may be more or less visible, the quality/energy tradeoff control module provides to the user some control of the amplitude of the defects via the Algorithm Strength, to favor either visual comfort or consumption reduction.

The control can be directly done by the user, in other words, directly controlled by a user setting 604 such as an action on a user interface element while displaying the visual content. Direct control may be provided by user input for example through a slider, a checkbox, a button, a combination of several of these elements or any other user interface element that will allow the user to increase or decrease, directly or indirectly, the algorithm strength value. Such an action impacts the amount of energy savings in correlation with the level of quality of experience.

The control can also be done indirectly by the user, for example through settings or parameters in a user profile 605. These settings may use the same user interface elements than the first embodiment to input the user choice with the difference that these settings would apply to all visual contents. In at least one embodiment, the user profile 605 can also be replaced by a device configuration. Indeed, a user profile is dependent on the user (or group of users) utilizing the device, so it requires an identification of a user to benefit from a user profile. A device configuration applies to all users of the device and thus, does not need such identification. The user profile and device configuration both offer the same features: allowing to setup some parameters in a configuration phase and apply these parameters during the normal use of the device to adapt the behavior to user or device preferences.

The control can also be done according to provider rules 606, in other words the quality/energy tradeoff is decided by the content provider and enforced by the device. For example, the provider of a blockbuster movie wants the audience to enjoy the pristine images, and this prevents any unintended processing of the images to ensure that the artistic intent of the producer is perceived. At the opposite, a producer of a talk show on the topic of environmental issues may want to enforce a maximal energy reduction to be consistent with the topic of the show.

All the above settings can be combined together. In this case, a priority mechanism prevents any conflicting settings, for example giving higher priority to the user settings over the other settings. Another option is to assign weights to each type of settings, and to realize a weighted sum.

The choice of the user can be further displayed through either the new amount of energy needed to display the content or the new quality level corresponding to the user choice or both the energy amount and the quality level, as an informative and optional feedback to the user. This amount of energy and/or quality can be displayed through numbers, colors, histogram bars or any other user interface widget that displays an amount of a characteristic. As far as the energy is concerned, the amount of energy consumed, or the amount of saved energy can be displayed. In the latter case, the feedback to the user can be transformed into the amount of carbon emission and/or a more illustrative and figurative representation such as icons illustrating the “wellness of the planet” for example.

FIG. 7 illustrates an example process for controlling the balance between energy consumption reduction and quality of experience according to embodiments. This process 700 is for example implemented by a processor 101 of a device 100 of FIG. 1. In step 710, the processor obtains the visual content, or a part of the visual content, for example an image of a sequence of images or video.

In step 720, the processor obtains the algorithm strength. As described above, this may be based on multiple inputs such as user setting, a user or device profile, a system status, or rules from the content provider.

In step 730, the energy reduction algorithm is applied to the visual content with the determined algorithm strength. A low value of the algorithm strength will only slightly impact the outcome and favors the quality of experience but will provide limited energy reduction. A high value of the algorithm strength will have a greater impact and thus favors the energy reduction at the cost of a decreased quality of experience. Indeed, in this case, artefacts may be introduced. The user has the control over this setting and can choose the right balance between quality of experience and amount of energy reduction.

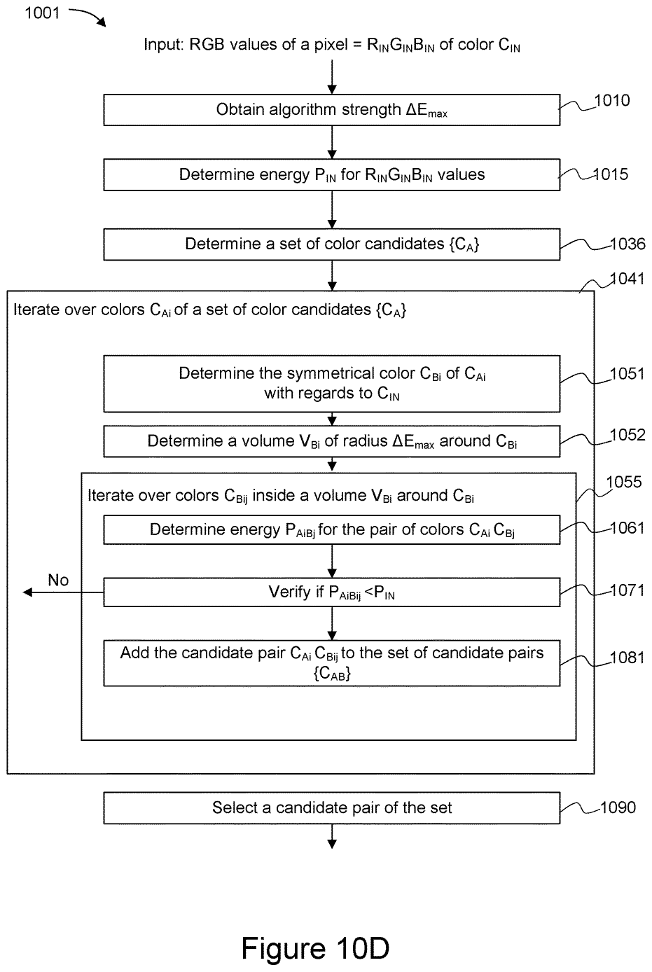

In at least one embodiment, when the value of the algorithm strength is null or lower than a threshold value, the algorithm is not applied (dotted line in the figure). Indeed, if the energy reduction is not significative enough, the energy needed for computing a modified content may be higher than the energy savings that would be provided by the modified content. Example values of such a threshold are 0.1 or 0.05. The application of the energy reduction algorithm can be done using the algorithms further described below with regard to FIG. 10A or 10D for example.

In step 740, the processor provides the modified (or unmodified) content. In an embodiment, the content is then directly displayed on the screen. In other embodiments, the content is provided to another device for further use, such as processing or display on another device.

FIG. 8 illustrates different examples of user interfaces for selecting an algorithm strength to control the balance between energy consumption reduction and quality of experience according to embodiments. These examples illustrate only the graphical element of a user interface that allows to control the strength. They do not represent the complete user interface.

A first example of graphical element 801 for controlling the algorithm strength is based on a slider that directly drives the Algorithm Strength, for example expressed in percentage of the maximal strength. Moving the cursor towards the right side increases the algorithm strength. Moving the cursor towards the left side decreases the algorithm strength. The cursor may be moved using conventional techniques such as using left and right arrows or by direct control through a touch screen. A value equal to zero (i.e., cursor at the far-left side) disables the energy reduction and bypasses the image modification. Optionally the user may also directly enter a numeric value, for example using digit keys or voice input. Optionally, a color range could be associated with the slider, varying between green on the right side and red on the left side, the more on the green side the more energy reduction.

Instead of a continuous slider providing precise setting (nearly continuous), a second example 802 displays discrete values. This example provides ten different values through a kind of level bar and shows a setting at 4 out of 10.

A third example of graphical element 803 for controlling the algorithm strength is based on a slider that drives the energy reduction rate provided by the algorithm, for example expressed in percentage of reduction. Optionally the user may also directly enter a numeric value or use a color range.

A fourth example of graphical element 804 for controlling the algorithm strength is based on a couple of interconnected sliders showing the relationship between algorithm strength and quality of experience. Indeed, when the user increases the algorithm strength using the slider on the top, the value of the second slider decreases simultaneously and vice versa. Optionally the user may also directly enter a numeric value or use a color range. The quality of experience may be measured using conventional image quality metrics (i.e., PSNR, SSIM, VMAF).

A fifth example of graphical element 805 for controlling the algorithm strength is based on a user interface panel where the user may select the algorithm strength amongst checkboxes labelled as “no energy reduction”, “small reduction”, “medium reduction”, “large reduction”, “maximal reduction”. These checkboxes correspond to predetermined values of algorithm strength, for example respectively 0, 0.1, 0.2, 0.4, 0.8.

A sixth example of graphical element 806 for controlling the algorithm strength is based on a slider that drives the quality of experience to be achieved by the algorithm, for example expressed in percentage of reduction.

In addition, the user interface may also display an indication of a measure of the quality of experience, for example in the form of a numerical value (i.e., percentage of similarity).

The person skilled in the art would think of many other conventional techniques (voice controlled, gestures, etc.) for entering the algorithm strength.

FIG. 9A illustrates the notion of indistinguishable colors represented by MacAdam ellipses for one of MacAdam's test participant. MacAdam set up an experiment in which a trained observer viewed two different colors, at a fixed luminance of about 48 cd/m². One of the colors (the “test” color) was fixed, but the other was adjustable by the observer, and the observer was asked to adjust that color until it matched the test color. This match was, of course, not perfect, since the human eye, like any other instrument, has limited accuracy. It was found by MacAdam, however, that all the matches made by the observer fell into an ellipse on the CIE 1931 chromaticity diagram. The measurements were made around 25 CIE 1931 xy color points on the chromaticity diagram, and it was found that the size and orientation of the ellipses on the diagram varied widely depending on the test color.

Therefore, a MacAdam ellipse is a region on a CIE 1931 xy chromaticity diagram which contains all colors which are indistinguishable, to the average human eye, from the color at the center of the ellipse. The contour of the ellipse therefore represents the just-noticeable differences of chromaticity. The ellipses illustrated in the figure are ten times their actual size. A chromaticity diagram is conventionally a color printed diagram displaying the whole spectrum of color variations. In order to respect the black and white representation for patent application, the color variations are here replaced by a completely white area.

MacAdam's results confirmed earlier suspicions that color difference could be measured using a metric in a chromaticity space. A number of attempts have been made to define a color space which is not as distorted as the CIE XYZ space. The most notable of these are the CIELUV and CIELAB color spaces (1976). Although both spaces are less distorted than the CIE XYZ space, they are not completely free of distortion. This means that the MacAdam ellipses become nearly (but not exactly) circular in these spaces.

CIELAB expresses color as three values: L* for perceptual lightness and (±)a* and (±)b* for the four unique colors of human vision: red, green opposition ((±)a*), blue, yellow opposition ((±)b*). CIELAB produces a color space that is more perceptually linear than previously defined color spaces. Perceptually linear means that a change of the same amount in a color value should produce a change of about the same visual importance for another color.

In a Lab space, a metric can be defined as well as a color distance. Given two colors in CIELAB color space,

$$( {L}_{1}^{*} , {a}_{1}^{*} , {b}_{1}^{*} ) and ( {L}_{2}^{*} , {a}_{2}^{*} , {b}_{2}^{*} )$$

the color difference formula may be defined as:

$$Δ {E}_{ob}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}} .$$

A color distance

$$Δ {E}_{ab 1}^{*}$$

can be evaluated to correspond to a JND=1.

Embodiments have been implemented in the OKLab space and uses the above distance formula to define a color region around an origin color with a color distance

$$Δ {E}_{abx}^{*}$$

to the input color C_{IN}. When using SACC or TACC, the average of a replacement color pair is chosen to be undistinguishable from the corresponding input color

$$( Δ {E}_{abx}^{*} < Δ {E}_{ab 1}^{*} , JND < 1 ) .$$

According to embodiments proposed herein, this constraint can be relaxed under control of the user. In other words, the average of a replacement color pair can be located to be slightly distinguishable from the corresponding input using a difference greater than

$$1 JND ( Δ {E}_{abx}^{*} ≳ Δ {E}_{ab 1}^{*} ) .$$

This allows to increase the search space for the pair or colors and possibly find pairs with stronger energy reduction.

The color difference may be represented by a color volume around the input color and the radius of this volume determines the distinguishability (or similarity) of the average of a replacement color pair and thus corresponds to the strength of the algorithm: the bigger the radius, the less similar but possibly the more energy reduction. Thus, the strength of the algorithm described above determines the radius of this similarity volume, hereafter named ΔEₘₐₓ. When the user determines a small similarity volume, the search space for a pair of colors requiring less energy is reduced and thus the reduction may be limited. When the user determines a bigger similarity volume, the search space for the pair of colors is greater and thus there are more chances to find a pair of colors requiring less energy. The bigger the radius of this similarity volume, the less similar the color will be but the more opportunities to find a pair requiring much less energy.

FIG. 9B illustrates an example of correspondence between the strength of the algorithm and the radius of a color similarity volume ΔEₘₐₓ according to embodiments. As introduced above, the algorithm strength can be characterized by a value in the interval [0,1], 0 representing a state with no change to the original image (and simultaneously no gain in energy) and 1 representing a situation with high gain in energy consumption (to the cost of image quality).

A first approach to relate AS to ΔEₘₐₓ is to define a scaling coefficient k, so that ΔEₘₐₓ=k·AS. In other words, in this case, the radius of the color similarity volume is a linear scaling of the algorithm strength, according to a scaling ratio k.

A second approach allows potentially for higher savings in energy by defining a function between AS and ΔEₘₐₓ. An example of such function can be defined as ΔEₘₐₓ=2k·AS/(1−AS). With such function:
For AS=0,4Eₘₐₓ=0
For AS=⅓, ΔEₘₐₓ=k (same range as in the linear case)
For AS=0.5, 4Eₘₐₓ=2k
For AS=⅔, ΔEₘₐₓ=4k
For AS=0.75, ΔEₘₐₓ=6k

In other words, the radius of the color similarity volume is varying with the algorithm strength, according to a scaling ratio k, at a higher increasing rate than a linear variation.

The example of function illustrated in the figure corresponds to an example where k=0.5. The horizontal axis represents the value of the algorithm strength AS, as selected by the user for example according to one of the user interface elements of FIG. 8. The vertical axis represents the value of the radius ΔEₘₐₓ of the color similarity volume.

FIG. 10A illustrates an example of process for establishing the pair candidates of alternating complementary colors according to a first embodiment. One goal of this first embodiment is that for every pixel color, the distance between the input color and the average color of the replacement colors (obtained according to the SACC or TACC techniques) is smaller than a reference maximal color distance relative to the input color. In other words, the average color is within a color volume around the input color, the radius of the color volume being defined by an algorithm strength chosen by the user. This process 1000 is for example implemented by a processor 101 of the device 100 of FIG. 1. The process operates in a selected color space {C}, preferably a uniform color space such as CIELab, IPT or OkLab. Uniform color spaces are built such that the same geometrical distance anywhere in the color space reflects the same amount of perceived color difference. In such color spaces, most often forward color transforms [symbol] (RGB) act on RGB to compute (CIE) XYZ and then Lab or equivalent visual coordinates (RGB to XYZ to Lab). Lab can also be computed directly from RGB (RGB to Lab). Inverse color transforms [symbol] (Lab) apply inverse operations (Lab to XYZ to RGB or directly Lab to RGB). The process is operated on an input pixel p of color C_{IN} (within the gamut {G} in the selected color space {C}) and represented by the input color triplet R_{IN}G_{IN}B_{IN}. In step 1010, the processor obtains an algorithm strength ΔEₘₐₓ, for example using one of the user interface elements illustrated in FIG. 8.

In step 1015, the processor determines the energy consumption [symbol] _{IN} for the input color triplet according to a selected color power consumption model. The power consumption model is display dependent. For OLED displays, the power consumption model can follow the color model, including the RGBW case where a white LED supports the RGB LEDs for each physical pixel. A color model for a RGBW display is given by Murdoch et al. in “Perfecting the color reproduction of RGBW OLED” proc. 30th International Congress of Imaging Science. This model can be extended with adequate parameters to represent per pixel power.

In step 1020, the processor determines a volume V_{IN} of radius ΔEₘₐₓ around C_{IN}. This volume defines the search space around the input color that is sampled to determine a set of colors {C_{INΔ}} for which a pair of replacement colors will be determined.

In step 1030, the processor iterates the steps 1035 and 1040 over the colors C_{INΔi} of the set of colors {C_{INΔ}}.

In step 1035, the processor samples the color space {C} within the gamut {G} to determine a set of candidate colors {C_{Ai}} for the first color of the pair of replacement colors with regards to the selected color C_{INΔi}. Different criteria may be used to determine the sampling space. In at least one embodiment, a “maximal color distance relative to the input color” criterion is used to limit the sampling to the color space around C_{INΔi}.

In embodiments, the set of candidates comprises saturated colors, or greyscale colors (i.e., part of the grey ramp: a_{C}_{_{Aij}}=0 and b_{C}_{_{Aij}}=0), or colors having the same luminance than C_{INΔi} (L_{C}_{_{Aij}}=L_{INΔi}) or a combination of these colors. In at least one embodiment, all the color gamut space is explored and thus the set of candidates is the full set of possible values. In at least another embodiment, a subset of the color gamut space is chosen, for example using a smaller color resolution. In another embodiment, a number of randomly selected candidates are used.

In step 1040, the process is then iterated over the steps 1050 to 1080 to build the set of candidate colors pairs for each color C_{Aij} over the set of candidate colors {C_{Ai}}. In step 1050, the processor determines, for a selected color C_{Aij} of the iteration, a second color C_{Bij} that is symmetrical to the color C_{Aij} with regards to the selected color C_{INΔi}. In Lab space, the coordinates of such color are defined as:

$$\{ \begin{matrix}{L}_{{C}_{Bij}} & = 2 \cdot {L}_{IN Δ i} - {L}_{{C}_{Aij}} \\ {a}_{{C}_{Bij}} & = 2 \cdot {a}_{IN Δ i} - {a}_{{C}_{Aij}} \\ {b}_{{C}_{Bij}} & = 2 \cdot {b}_{IN Δ i} - {b}_{{C}_{Aij}}\end{matrix}$$

where L_{INΔi}, a_{INΔi}, bL_{INΔi} are the Lab coordinates of the selected color C_{INΔi},
L_{C}_{_{Aij}}, a_{C}_{_{Aij}}, b_{C}_{_{Aij}} are the Lab coordinates of the selected color C_{Aij} of the iteration over the set of candidate colors {C_{Ai}} with regards to the selected color C_{INΔi}, and
L_{C}_{_{Bij}}, a_{C}_{_{Bij}}, b_{C}_{_{Bij}} are the Lab coordinates of the second color C_{Bij} of the pair of colors.

This ensures that the combination of pixels of alternating complementary colors C_{Aij} and C_{Bij} will look similar to a pixel of color C_{IN}. Indeed, the color C_{INΔi} resulting from this combination is the average of colors C_{Aij} and C_{Bij} in the color space {C} and is within the volume V_{IN} of radius ΔEₘₐₓ around C_{IN}.

The processor verifies that the color C_{B}ij is comprised in the gamut {G} of the color space {C}. Indeed, if the color is out of the gamut range, it cannot be displayed so that the combination of colors C_{Aij} and C_{Bij} will not be perceptually the same as a color C_{IN}. If the color is out of the gamut, the iteration stops for the selected value of C_{Aij} since it does not lead to a correct pair of colors for the temporally successive pixels. In this case, the process starts again the iteration with step 1050 for the next value of C_{Aij} if any is remaining in the set.

In step 1060, the processor determines the corresponding triplets R_{Aij}G_{Aij}B_{Aij} and R_{Bij}G_{Bij}B_{Bij} for the pair of colors C_{Aij} and C_{Bij} and determines the energy consumption P_{AijBij} of the combination of the pair of colors C_{Aij}, C_{Bij}. Since the power consumption model of the display device is not necessarily known, the energy consumption for displaying a color can simply be approximated by the sum of its RGB values to the power gamma. In embodiments where the pair of colors C_{Aij} and C_{Bij} are applied to pixels half the size (SACC) or duration (TACC) than the pixel of color C_{IN}, this is evaluated as:

$${𝒫}_{AijBij} = \frac{1}{2} 𝒫 ( {R}_{Aij} {G}_{Aij} {B}_{Aij} ) + \frac{1}{2} 𝒫 ( {R}_{Bij} {G}_{Bij} {B}_{Bij} )$$

In step 1070, the processor verifies that [symbol] _{AijBij}< [symbol] _{IN}. Indeed, a candidate pair of colors for the temporally successive pixels is only considered when it brings an energy reduction. If it is not the case, then the candidate pair is discarded, and the process starts again the iteration with step 1050 for the next value of C_{Aij} if any is remaining in the set. The test can also be formulated as [symbol] _{Aij}+ [symbol] _{Bij}<2. [symbol] _{IN} with [symbol] _{Aij}, [symbol] _{Bij}, [symbol] _{IN} respectively representing the energy of a pixel of color C_{Aij}, C_{Bij}, C_{IN}. In other words, a candidate pair of alternating complementary colors is considered when the sum of the energies of the pair of alternating complementary colors is lower than twice the energy of the input color. When this test is verified, in step 1080, the processor adds the candidate pair C_{Aij}, C_{Bij} to the set of candidate pairs {CAB}.

In step 1090, the processor selects one of the candidate pairs of the set of candidate pairs {C_{AB}} as the pair of colors to replace the color C_{IN}. In at least one variant, the processor identifies in the list of the candidate pairs {C_{AB}} the position of the candidate pair that has the lowest energy consumption:

$$xmin = argmin \{ \frac{1}{2} 𝒫 ( {R}_{A} j {G}_{Aj} {B}_{Aj} ) + \frac{1}{2} 𝒫 ( {R}_{B} {G}_{B} {B}_{B} ) \}$$

As a result, the processor determines {C̅_̅{̅A̅}̅C̅_̅{̅B̅}̅}ₓₘᵢₙ as being the best replacement for C_{IN}. Replacing a pixel of color C_{IN} by two adjacent pixels of color C_{Axmin} and C_{Bxmin}, each of half size (SACC) or by two temporally successive pixels of color C_{Axmin} and C_{Bxmin}, each over a half period (TACC), will allow to reduce the energy consumption while keeping an excellent quality of experience since the replacing pixels will be perceived by a human observer as a single pixel of color similar to the color C_{IN}.

In at least one embodiment, a mathematical minimization method, for example a Least Squares minimization, is used to replace the steps 1020 to 1080 to find the correspondence between a color C_{IN} and its best color pair replacement C_{Axmin}, C_{Bxmin}.

In at least one embodiment, an additional step is added before the step 1010 to check that the triplet R_{IN}G_{IN}B_{IN} Spatially belongs to a subset of the image to be processed, for example belonging to a region in the image having the highest ability to mask artefacts. Such a region or mask can be given by for example a spatio-temporal just noticeable difference (JND) map, a motion field, a saliency map, etc. If the triplet R_{IN}G_{IN}B_{IN} does not belong to this region or mask, no color pair replacement will be considered for this color and thus the process steps 1010 to 1090 will not be performed.

In at least one embodiment, the triplets {R_{IN}G_{IN}B_{IN}} are ordered according to their consumed energy so that the triplets are processed in decreasing order from the highest consuming to the lowest consuming ones. In such a case, a threshold might be defined corresponding to a global energy reduction to achieve. When this threshold is reached for a given number of triplets processed, the global process is stopped. Other ordering criteria may be defined, such as determining on a display which are the RGB combinations which consume energy and can be replaced with maximum effect. A map in the color space can be built storing the replacement power ratio

$${R}_{p} = \frac{P ( {C}_{IN} )}{P ( {C}_{Ax min} ) + P ( {C}_{Bx min} )}$$

and the set of colors is sorted by decreasing Rp before the replacement is made for image pixels. Other examples of ordering would be to make it depend on the distance between the input color and the replacement colors, or to select first the RGB value at the limit of the gamut, or to select according to decreasing saturation values.

In at least one embodiment, the correspondence between a color C_{IN} and a color pair replacement is established using the process 1000 (for example the pair with the lowest energy consumption C_{Axmin}, C_{Bxmin}) is stored in a table so that the subsequent color replacement can be done very efficiently. Providing the input color to the table would allow to get immediately the corresponding color pair without having to perform again the whole process 1000. Such table is associated with an algorithm strength. Multiple tables may be defined to support different algorithm strengths.

FIG. 10B illustrates examples of colors selected according to the first embodiment. In this figure, C_{IN} represents an input color. The first iteration 1030 is done over i colors by sampling colors within the volume V_{IN} of radius ΔEₘₐₓ around C_{IN}, for example C_{INΔi} and C_{INΔi′} as illustrated, leading to the set of colors {C_{INΔ}}. These colors are considered as being similar to the input color C_{IN}. The second iteration 1040 is done over j colors by sampling the color space {C} within the gamut {G} to determine a set of candidate colors {C_{Ai}} for the first color of the pair of replacement colors. This second iteration is performed with regards to the selected color C_{INΔi} of the first iteration (thus the index ‘i’), for example C_{Aij} and C_{Aij′} as illustrated. The symmetrical colors to candidate colors {C_{Ai}} are then determined, for example C_{Bij} and C_{Bij′} respectively corresponding to colors C_{Aij} and C_{Aij′}. The iterations are repeated over all other candidate colors {C_{Ai}} for all other similar colors {C_{INΔ}}.

FIG. 10C illustrates examples of colors selected according to a second embodiment. In this figure, C_{IN} represents an input color. A first iteration is done over i colors by sampling the color space {C} within the gamut {G} to determine a set of candidate colors {C_{A}} for the first color of the pair of replacement colors. The symmetrical colors to candidate colors {C_{A}} are then determined, corresponding to the second color of the pair, for example C_{Bi} and C_{Bi′} respectively corresponding to colors C_{Ai} and C_{Ai′}. A second iteration is done over j colors by sampling colors within the volume V_{IN} of radius ΔE_{max′} around C_{Bi}, for example C_{Bij} and C_{Bij′}, leading to the set of second colors of the pair {C_{Bi}}. ΔE_{max′} is chosen as being two times ΔEₘₐₓ so that the distance between the average color of the candidates and the input color is lower than, or equal to ΔEₘₐₓ. As a result, the average of each of the second color of the pair of colors {C_{Bi}} with the first pair C_{Ai} results in a color that is similar to the input color, for example C_{INΔij} and C_{INΔij′} as illustrated, respectively for C_{Bij} and C_{Bij′}.

FIG. 10D illustrates an example of process for establishing the pair candidates of alternating complementary colors according to the second embodiment. This process 1001 is for example implemented by a processor 101 of the device 100 of FIG. 1. The process 1001 is very similar to the process 1000 of FIG. 10A. One goal of this second embodiment is that for every pixel color the distance between the input color and the average color of the replacement colors (obtained according to the SACC or TACC techniques) is smaller than a reference maximal color distance relative to the input color. The main difference with the first embodiment is that, instead of dimensioning a similarity volume around the input color, the similarity volume is applied around the second color C_{B} that is symmetrical to the color C_{A}. The radius of the similarity volume is twice the radius of the first embodiment. It also results into generating couple of colors whose average color is similar to the input color but not exactly identical to the input color. Steps 1010, 1015, and 1090 are identical to the equivalent steps of FIG. 9A, steps 1051, 1061, 1071, 1081 are similar to corresponding steps 1050, 1060, 1071, and 1080 but operate on different input.

Similar to FIG. 10A, the algorithm strength is obtained in step 1010, and the energy consumption [symbol] _{IN} for the input color triplet is determined in step 1015.

In step 1036, the processor samples the color space {C} within the gamut {G} to determine a set of candidate colors {C_{A}} for the first color of the pair of replacement colors with regards to the input color C_{IN}.

In step 1041, the processor iterates the steps 1051, 1052, 1055, 1061, 1071 and 1081 over colors C_{Ai} of the set of candidate colors {C_{A}}.

In step 1051, the processor determines, for a selected color C_{Ai}, a second color C_{Bi} that is symmetrical to the color C_{Ai} with regards to the input color C_{IN}.

In step 1052, the processor determines a volume V_{Bi} of radius ΔEₘₐₓ, around C_{Bi}. ΔE_{max′} is chosen as being two times ΔEₘₐₓ.

In step 1055, this volume is sampled to determine a set of second colors {C_{Bij}} that, combined with the selected color C_{Ai}, form a set of temporary candidate pairs of replacement colors. By construction, the distance between the average color of the candidate pair C_{Ai}, C_{Bij} and the input color C_{IN} is lower than, or equal to ΔEₘₐₓ, thus respecting the expected color similarity.

In step 1061, the processor determines the corresponding triplets R_{Ai}G_{Ai}B_{Ai} for the color C_{Ai} and R_{Bij}G_{Bij}B_{Bij} for the color C_{Bij} and determines the energy consumption [symbol] _{AiBij} of the combination of the pair of colors C_{Ai}, C_{Bij}.

In step 1071, the processor verifies that [symbol] _{AjBij}< [symbol] _{IN}. When this test is verified, in step 1081, the processor adds the temporary candidate pair C_{Ai}, C_{Bij} to the set of candidate pairs {C_{AB}}.

In step 1090, the processor selects one of the candidate pairs of the set of candidate pairs {C_{AB}} as the pair of colors to replace the color C_{IN}, for example the one with the lowest value of energy consumption.

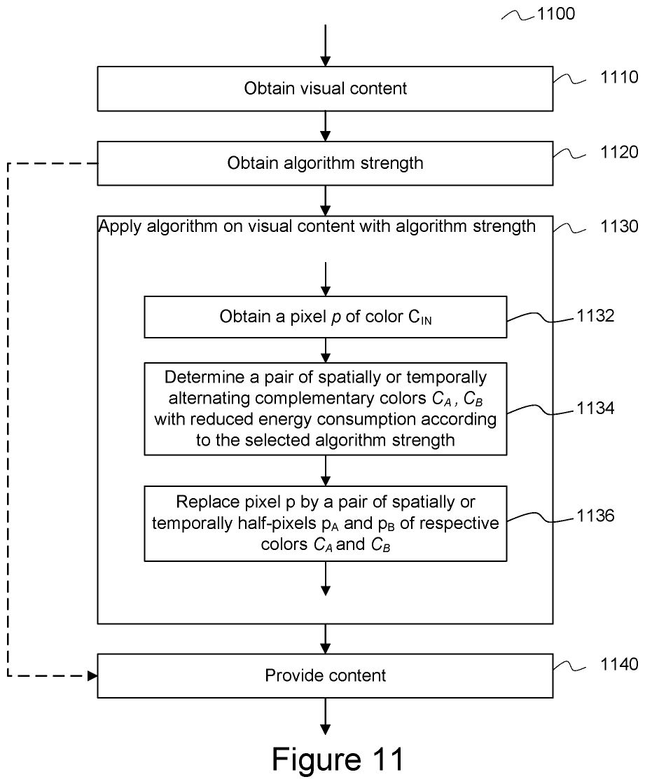

FIG. 11 illustrates an example of process for reducing the energy consumption for a pixel of an image using alternating complementary colors according to embodiments. This process 1100 is for example implemented by a processor 101 of the device 100 of FIG. 1. This flowchart is very similar to the flowchart of FIG. 7 but while the description of FIG. 7 relates to controlling the balance between energy consumption reduction and quality of experience, the FIG. 11 brings more details to the image modification aspect.

In at least one embodiment, the process 1100 is iterated on a set of colors comprising colors of all pixels of an input image. In another embodiment, the process 1100 is iterated on a set of colors comprising all possible color values according to a selected color space. In other embodiments, the iteration is done on a subset of the pixels or a subset of the color space.

In step 1110, the processor obtains the visual content, or a part of the visual content, for example an image of a sequence of images comprising a set of pixels.

In step 1120, the processor obtains the algorithm strength. As described with reference to FIG. 6, this may be based on multiple inputs such as a user setting, a user profile, or other inputs.

In step 1130, the energy reduction algorithm is applied to the visual content with the determined algorithm strength. The step 1130 is iterated over the pixels of the visual content. In step 1132, the processor obtains a pixel p of color C_{IN}. In step 1134, the processor determines a pair of spatially or temporally alternating complementary colors C_{A}, C_{B} with reduced energy consumption according to the selected algorithm strength. The average color of the colors C_{A}, C_{B} is within a similarity volume around the input color C_{IN}, the radius of the similarity volume being defined by the determined algorithm strength. In step 1136, the processor replaces pixel p by a pair of spatially or temporally half-pixels p_{A} and p_{B} of respective colors C_{A} and C_{B}, either using the spatially alternating complementary color technique or the temporally alternating complementary color technique described above.

In step 1140, the modified visual content is provided, for example displayed on a screen or transmitted on a communication network.

A low value of the algorithm strength will only slightly impact the outcome. In at least one embodiment, when the value of the algorithm strength is null or lower than a threshold value, the algorithm is not applied (dotted line in the figure) and the visual content is provided unmodified in step 1140. Indeed, if the energy reduction is not significative enough, the energy needed for computing a modified content may be higher than the energy savings that would be provided by the modified content. Example values of such threshold are 0.1 or 0.05.

In at least an embodiment, the step 1134 uses the process 1000 of FIG. 10A or the process 1001 of FIG. 10D. In another embodiment, this step uses a table storing an association between an input color and a pair of replacement colors, for a given algorithm strength. Such a table may be obtained by iterating the process 1000 of FIG. 10A or the process 1001 of FIG. 10D over all the range of values for the input color and storing the association between an input color and a pair of replacement colors. Multiple tables may be generated for different values of algorithm strength, for example the predetermined values corresponding to the checkboxes of the graphical element 805 of FIG. 8. In this case, a first table would be used for 10% reduction (0.1 value), a second for 20%, a third for 40% and a fourth for 80%. In step 1136, the processor replaces the pixel p of color C_{IN} by a couple of pixels p_{A}, p_{B} of colors C_{A}, C_{B}, according to the SACC or TACC techniques described above. In practice, in at least one embodiment, the pixels p_{A}, p_{B} are half-sized compared to pixel p, either spatially or temporally.

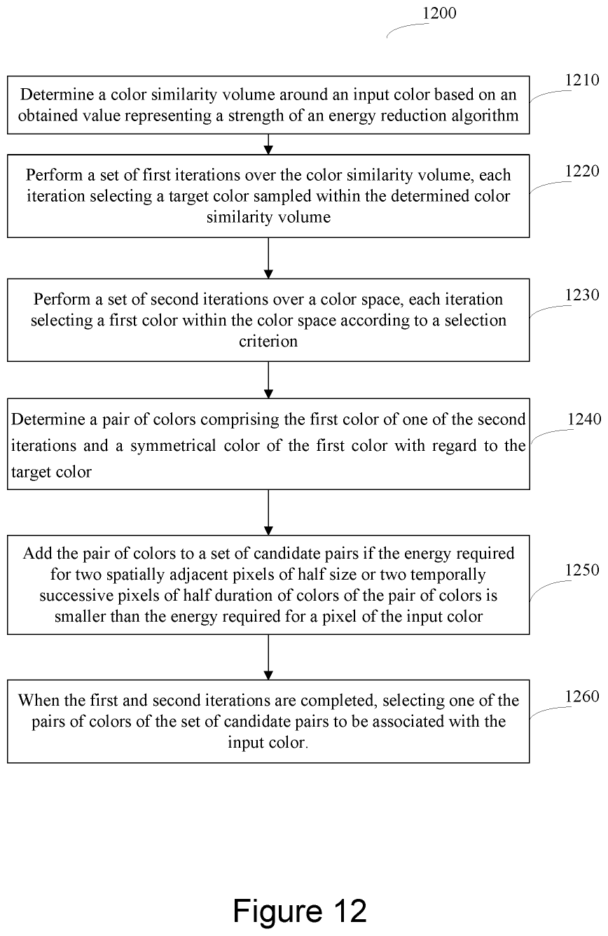

FIG. 12 illustrates an example of process for associating a pair of alternating complementary colors to an input color according to embodiments. This process 1200 is for example implemented by a processor 101 of the device 100 of FIG. 1. In step 1210, the processor determines a color similarity volume around an input color based on an obtained value representing a strength of an energy reduction algorithm. In step 1220, the processor performs a set of first iterations over the color similarity volume, each iteration selecting a target color sampled within the determined color similarity volume. In step 1230, the processor performs a set of second iterations over a color space, each iteration selecting a first color within the color space according to a selection criterion. In step 1240, the processor determines a pair of colors comprising the first color of one of the second iterations and a symmetrical color of the first color with regard to the target color. In step 1250, the processor adds the pair of colors to a set of candidate pairs if the energy required for two spatially adjacent pixels of half size or two temporally successive pixels of half duration of colors of the pair of colors is smaller than the energy required for a pixel of the input color. In step 1260, when the first and second iterations are completed, the processor selects one of the pairs of colors of the set of candidate pairs to be associated with the input color.

Although some parts of the description refer to images, the embodiments are not restricted to images and apply to any type of visual media content such as conventional (2D) videos, stereoscopic (3D) images or videos, 360° immersive images or video, based on the same principles as described above but iterated temporally and/or spatially.

In general, one or more other examples of embodiments can also provide a computer readable storage medium, e.g., a non-volatile computer readable storage medium, having stored thereon instructions for encoding or decoding picture information such as video data according to the methods or the apparatus described herein. One or more embodiments can also provide a computer readable storage medium having stored thereon a bitstream generated according to methods or apparatus described herein. One or more embodiments can also provide methods and apparatus for transmitting or receiving a bitstream or signal generated according to methods or apparatus described herein.

Many of the examples of embodiments described herein are described with specificity and, at least to show the individual characteristics, are often described in a manner that may sound limiting. However, this is for purposes of clarity in description, and does not limit the application or scope of those aspects. Indeed, all the different aspects can be combined and interchanged to provide further aspects. Moreover, the embodiments, features, etc. can be combined and interchanged with others described in earlier filings as well.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it also provides a block diagram of a corresponding apparatus. Similarly, when a figure is presented as a block diagram, it also provides a flow diagram of a corresponding method/process.

In general, the examples of embodiments, implementations, features, etc., described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. One or more examples of methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users. Also, use of the term “processor” herein is intended to broadly encompass various configurations of one processor or more than one processor.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Various embodiments are described herein. Features of these embodiments can be provided alone or in any combination, across various claim categories and types.

As described in reference to FIG. 10D, a method is described, the method comprising performing a first iteration over a color space successively selecting a first color within the color space according to a selection criterion, determining a second color determined as the symmetrical color of the selected color with regards to an input color, determining a color similarity volume around the second color based on an obtained algorithm strength, performing a second iteration over the color similarity volume, each iteration determining a new pair of colors comprising the selected color of the first iteration and a candidate for the second color sampled within the color similarity volume, adding the new pair of colors if the energy required for two spatially adjacent pixels of half size or two temporally successive pixels of half duration of colors of the new pair of colors is smaller than the energy required for a pixel of the input color, once the first and second iterations are completed, selecting one of the pairs of colors of the set of candidate pairs. Similarly, an apparatus is described, the apparatus comprising a processor configured to perform a first iteration over a color space successively selecting a first color within the color space according to a selection criterion, determine a second color determined as the symmetrical color of the selected color with regards to an input color, determine a color similarity volume around the second color based on an obtained algorithm strength, perform a second iteration over the color similarity volume, each iteration determining a new pair of colors comprising the selected color of the first iteration and a candidate for the second color sampled within the color similarity volume, add the new pair of colors if the energy required for two spatially adjacent pixels of half size or two temporally successive pixels of half duration of colors of the new pair of colors is smaller than the energy required for a pixel of the input color, once the first and second iterations are completed, select one of the pairs of colors of the set of candidate pairs.

1. A method for reducing energy consumption when displaying visual content on a display device, characterized by:
determining a color similarity volume within a perceptually uniform color space around an input color of an input image pixel, the color similarity volume having a radius determined based on an obtained value representing a strength of an energy reduction algorithm;
performing a set of first iterations over the color similarity volume, each iteration selecting a target color sampled within the determined color similarity volume;
performing a set of second iterations over the color space, each iteration selecting a first color within the color space according to a selection criterion;
determining a pair of colors comprising the first color of one of the second iterations and a second color, the second color being determined as being symmetrical to the first color with regard to the target color in the color space;
adding the pair of colors to a set of candidate pairs if an energy required for displaying two spatially adjacent pixels of half size or two temporally successive pixels of half duration of colors of the pair of colors is smaller than an energy required for displaying a pixel of the input color; and
when the first and second iterations are completed, selecting one of the pairs of colors of the set of candidate pairs to be associated with the input color.

2. The method of claim 1, wherein the selection criterion for the second iterations is selected among a set comprising a maximal color distance relative to the input color, a saturated color, a greyscale color, the color has the same luminance than the input color.

3. The method of claim 1, wherein the pair of colors of the set of candidate pairs selected is the pair of colors with the lowest energy required.

4. The method of claim 1, wherein the first and second iterations are further iterated for a plurality of input colors comprising the colors of all pixels of an input image or of a subset of all pixels of the input image.

5. The method of claim 1, wherein the first and second iterations are iterated for a plurality of input colors comprising all possible color values of a color space or a subset of all possible color values of a color space.

6. The method of claim 1, further comprising storing, for a plurality of colors, an association between an input color and the selected pair of colors of the set of candidate pairs for the input color.

7. The method of claim 6, wherein the method is iterated on a plurality of values for algorithm strength.

8. The method of claim 6, wherein the association is stored in a table using an input color as index.

9. A method comprising:
obtaining a visual content;
obtaining a value representative of a strength for an algorithm that reduces energy consumption needed for the visual content;
determining a modified visual content by applying the algorithm on the visual content with the obtained algorithm strength value; and
providing the modified visual content,
wherein the algorithm implements the method of claim 1.

10. The method of claim 9, wherein the value representative of the algorithm strength is obtained through a user interface providing means for adjusting a value representative of the algorithm strength or obtained from a memory.

11. The method of claim 9, wherein the value representative of the algorithm strength value is adjusted using a slider, a checkbox, a button, or a combination of several of these elements.

12. An apparatus comprising a processor configured to:
determine a color similarity volume within a perceptually uniform color space around an input color of an input image pixel, the color similarity volume having a radius determined based on an obtained value representing a strength of an energy reduction algorithm;
perform a set of first iterations over the color similarity volume, each iteration selecting a target color sampled within the determined color similarity volume;
perform a set of second iterations over a color space, each iteration selecting a first color within the color space according to a selection criterion;
determine a pair of colors comprising the first color of one of the second iterations and a second color, the second color being determined as being symmetrical to the first color with regard to the target color in the color space;
add the pair of colors to a set of candidate pairs if an energy required for displaying two spatially adjacent pixels of half size or two temporally successive pixels of half duration of colors of the pair of colors is smaller than an energy required for displaying a pixel of the input color; and
when the first and second iterations are completed, select one of the pairs of colors of the set of candidate pairs to be associated with the input color.

13. An apparatus comprising a processor configured to:
obtain a visual content;
obtain a value representative of a strength for an algorithm that reduces energy consumption needed for the visual content;
determine a modified visual content by applying the algorithm on the visual content with the obtained algorithm strength value based on pairs of colors determined based on claim 12; and
provide the modified visual content.

14. (canceled)

15. A non-transitory computer readable medium storing executable program instructions to cause a computer executing the instructions to perform a method according to claim 1.

16. The apparatus of claim 12, wherein the selection criterion for the second iterations is selected among a set comprising a maximal color distance relative to the input color, a saturated color, a greyscale color, the color has the same luminance than the input color.

17. The apparatus of claim 12, wherein the pair of colors of the set of candidate pairs selected is the pair of colors with the lowest energy required.

18. The apparatus of claim 12, wherein the processor is configured to store, for a plurality of colors, an association between an input color and the selected pair of colors of the set of candidate pairs for the input color.

19. The apparatus of claim 18, wherein the processor is configured to iterate on a plurality of values for algorithm strength.

20. The apparatus of claim 18, wherein the association is stored in a table using an input color as index.

21. The apparatus of claim 13, wherein the value representative of the algorithm strength is obtained through a user interface providing means for adjusting a value representative of the algorithm strength by using a slider, a checkbox, a button, or a combination of several of these elements or is obtained from a memory.
